(19) United States
(12) Patent Application Publication
(10) Pub. No.: US 2022/0269520 A1
(43) Pub. Date: Aug. 25, 2022

(54) FACTOR IDENTIFICATION METHOD AND INFORMATION PROCESSING DEVICE

(71) Applicant: FUJITSU LIMITED, Kawasaki-shi (JP)

(72) Inventors: MASAO YAMAMOTO, Kawasaki (JP); Naoki OGUCHI, Kawasaki (JP); Masaaki Noro, Kawasaki (JP); Yosuke Takano, Kawasaki (JP)

(73) Assignee: FUJITSU LIMITED, Kawasaki-shi (JP)

(21) Appl. No.: 17/534,492

(22) Filed: Nov. 24, 2021

(30) Foreign Application Priority Data
Feb. 25, 2021 (JP) 2021-028768

(51) Int. Cl. G06F 9/455

(52) U.S. Cl. CPC G06F 9/45533

(57) ABSTRACT

A non-transitory computer-readable recording medium stores a program for causing a computer to execute a factor identification process, the factor identification process includes detecting an occurrence time point when a system call of a host operating system (OS) has occurred, acquiring switching operation information that enables an environment switching time point to be identified, the environment switching time point being a time point when an environmental process has switched, the environmental process implementing a software execution environment which is in operation on the host OS and is isolated from the host OS, identifying, based on the switching operation information, a first environmental process which is in operation on the host OS at the occurrence time point, and outputting the first environmental process in association with the system call.

### CROSS-REFERENCE TO RELATED APPLICATION

This application is based upon and claims the benefit of priority of the prior Japanese Patent Application No. 2021-28768, filed on Feb. 25, 2021, the entire contents of which are incorporated herein by reference.

### FIELD

The embodiment discussed herein is related to a factor identification method and an information processing device.

### BACKGROUND

Conventionally, an application implements file access processing and the like by calling a system call of a host operating system (OS). In order to find bottlenecks in the file access processing and the like, it is desirable to identify which application in which software execution environment implemented in a virtual machine (VM) or a container on the virtual machine the occurrence of the system call of the host OS related to the file access processing has been caused by.

As related art, for example, there is a technique to identify, when a predetermined failure is not detected, that failure information is generated by the virtual machine in a first virtual system. Furthermore, for example, there is a technique to compare a graph at the current time, in which each component is assumed as a node and the correlation between respective components is an edge, with a saved past graph and determine that a failure has occurred in a virtualization infrastructure if time series fluctuation of a graph structure is different from normal.

Japanese Laid-open Patent Publication No. 2015-143944 and Japanese Laid-open Patent Publication No. 2018-160020 are disclosed as related art.

### SUMMARY

According to an aspect of the embodiment, a non-transitory computer-readable recording medium stores a program for causing a computer to execute a factor identification process, the factor identification process includes detecting an occurrence time point when a system call of a host operating system (OS) has occurred, acquiring switching operation information that enables an environment switching time point to be identified, the environment switching time point being a time point when an environmental process has switched, the environmental process implementing a software execution environment which is in operation on the host OS and is isolated from the host OS, identifying, based on the switching operation information, a first environmental process which is in operation on the host OS at the occurrence time point, and outputting the first environmental process in association with the system call.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating one example of a factor identification method according to an embodiment;

FIG. 2 is an explanatory diagram illustrating one example of an information processing system;

FIG. 3 is an explanatory diagram illustrating a specific example of the information processing system;

FIG. 4 is a block diagram illustrating a hardware configuration example of a monitoring device;

FIG. 5 is an explanatory diagram illustrating one example of content stored in a first mapping information management table;

FIG. 6 is an explanatory diagram illustrating one example of content stored in a second mapping information management table;

FIG. 7 is an explanatory diagram illustrating one example of content stored in a third mapping information management table;

FIG. 8 is an explanatory diagram illustrating one example of content stored in a system call management table;

FIG. 9 is an explanatory diagram illustrating one example of content stored in a VM switching information management table;

FIG. 10 is an explanatory diagram illustrating one example of content stored in an on-VM process switching information management table;

FIG. 11 is a block diagram illustrating a functional configuration example of the monitoring device;

FIG. 12 is an explanatory diagram (No. 1) illustrating one example of operation of the monitoring device;

FIG. 13 is an explanatory diagram (No. 2) illustrating one example of the operation of the monitoring device;

FIG. 14 is an explanatory diagram (No. 1) illustrating a first specific example of the operation of the monitoring device;

FIG. 15 is an explanatory diagram (No. 2) illustrating the first specific example of the operation of the monitoring device;

FIG. 16 is an explanatory diagram (No. 3) illustrating the first specific example of the operation of the monitoring device;

FIG. 17 is an explanatory diagram (No. 1) illustrating a second specific example of the operation of the monitoring device;

FIG. 18 is an explanatory diagram (No. 2) illustrating the second specific example of the operation of the monitoring device;

FIG. 19 is a flowchart (No. 1) illustrating one example of an overall processing procedure; and

FIG. 20 is a flowchart (No. 2) illustrating one example of the overall processing procedure.

### DESCRIPTION OF EMBODIMENT

In related art, it is difficult to identify which application on which virtual machine or which application on which container on which virtual machine the occurrence of the system call of the host OS has been caused by. The software execution environment implemented by the virtual machine or the container is generated isolated from the host OS, and thus it is not possible to identify which application in which software execution environment the occurrence of the system call of the host OS has been caused by.

Hereinafter, an embodiment according to the present disclosure will be described in detail with reference to the drawings.

One Example of Factor Identification Method According to Embodiment

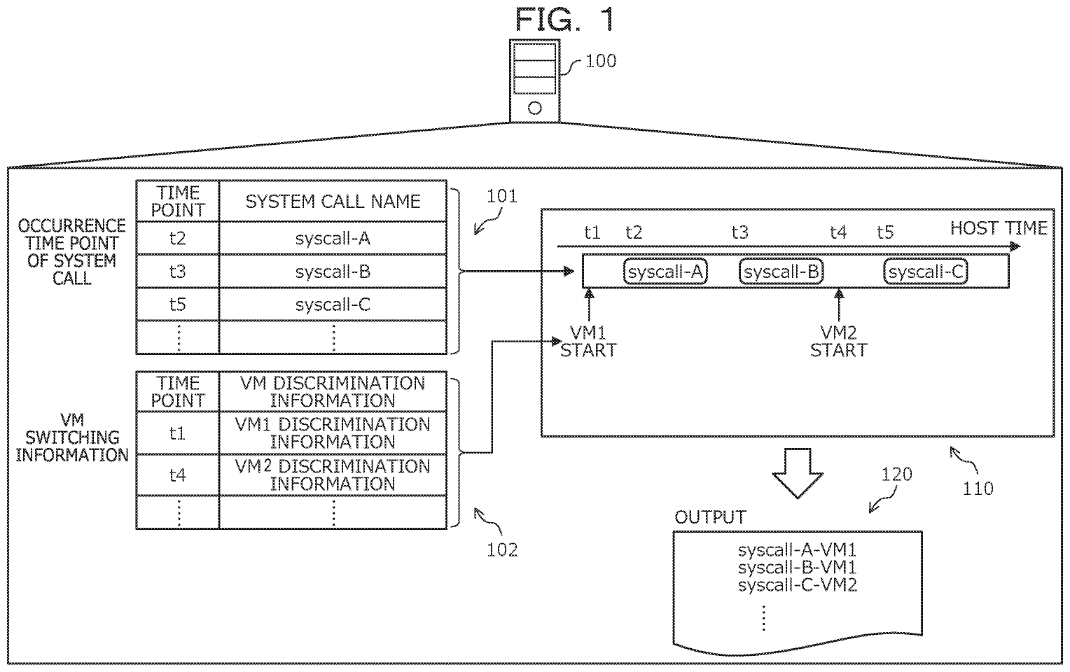

FIG. 1 is an explanatory diagram illustrating one example of a factor identification method according to an embodiment. A monitoring device 100 is a computer for easily identifying a factor that has caused a system call of a host OS. The system call of the host OS is called by an application to implement network processing such as file access processing or the like. An application is, for example, a process that operates on a host OS, a virtual machine, or a container.

In order to find bottlenecks in various types of processing such as network processing or file access processing, it is desirable to identify the factor that has caused the system call of the host OS related to various types of processing. For example, it is desirable to identify which application in which software execution environment implemented in the host OS, VM, or container the occurrence of the system call of the host OS has been caused by. In the following description, there may be cases where the software execution environment is simply described as “execution environment”.

However, conventionally, it may be difficult to identify the factor that has caused the system call of the host OS, that is, in which application in which execution environment the system call of the host OS has been caused.

For example, a method called full stack trace is conceivable in which a flow of network packets is tracked to find a bottleneck in network processing. With this method, it is not possible to identify the factor that has caused the system call of the host OS, and thus there is a problem that it is not possible to find the bottleneck in the file access processing.

Furthermore, for example, a method of monitoring a process and capturing (monitoring) which system call of the host OS has occurred, by using an extended Berkeley Packet Filter (eBPF) function provided in the LINUX® OS that is the host OS is conceivable. LINUX® is a registered trademark. Here, the execution environment implemented by the VM or the container is generated isolated from the host OS. Thus, this method has a problem that it is not possible to identify which application in which execution environment the occurrence of the system call of the host OS has been caused by.

Moreover, for example, a method that attempts to identify the factor that has caused the system call of the host OS by using the eBPF function provided in a guest OS on each VM is conceivable. For example, a method that attempts to measure in advance the time point when the system call occurs on the host OS and on each VM respectively and to verify the measured time point to identify the factor that has caused the system call on the host OS is conceivable. This method has a problem that if there is a deviation between a clock that the host OS has and a clock that each VM has, it becomes difficult to identify the factor that has caused the system call of the host OS. For example, in the present embodiment, it is quite difficult to correct the deviation between the clock that the host OS has and the clock that each VM has because nanosecond-level accuracy is required.

Therefore, in the present embodiment, a method that may enable the factor that has caused the system call of the host OS to be identified will be described.

(1-1) The monitoring device 100 detects an occurrence time point when the system call of the host OS has occurred. The monitoring device 100 detects, for example, the occurrence time point when the system call of the host OS has occurred by using the eBPF function provided in the host OS, and records the occurrence time point in a table 101. In the table 101, for example, an occurrence time point “t2” when a system call “syscall-A” has occurred, an occurrence time point “t3” when a system call “syscall-B” has occurred, and an occurrence time point “t5” when a system call “syscall-C” has occurred are recorded.

(1-2) The monitoring device 100 acquires operation information that enables a switching time point when a process that implements the execution environment isolated from the host OS, which is in operation on the host OS, has switched, to be identified. The process that implements the execution environment is the VM. For example, the monitoring device 100 sets a hook in a context switch function, detects the switching time point when the process that implements the execution environment, which is in operation on the host OS, has switched by using the set hook, and records the switching time point in a table 102. The hook is a statement added to a program. The hook is, for example, an instruction statement added to a function, and specifies a new process for detecting the switching time point. In the table 102, for example, the switching time point “t1” when a process in operation on the host OS has switched to a VM VM1 and the switching time point “t4” when the process has switched to a VM VM2 are recorded.

(1-3) The monitoring device 100 identifies a process that implements one of the execution environments in operation on the host OS at the detected occurrence time point on the basis of the acquired operation information. The monitoring device 100 identifies VM1 in operation at the occurrence time point “t2” when the system call “syscall-A” has occurred, on the basis of the relationship between the occurrence time point illustrated in a graph 110 and the switching time point, for example, with reference to the tables 101 and 102. The monitoring device 100 identifies VM1 in operation at the occurrence time point “t3” when the system call “syscall-B” has occurred, on the basis of the relationship between the occurrence time point illustrated in the graph 110 and the switching time point, for example, with reference to the tables 101 and 102. The monitoring device 100 identifies VM2 in operation at the occurrence time point “t5” when the system call “syscall-C” has occurred, on the basis of the relationship between the occurrence time point illustrated in the graph 110 and the switching time point, for example, with reference to the tables 101 and 102.

(1-4) The monitoring device 100 outputs the identified process that implements one of the execution environments in association with the system call. The monitoring device 100 outputs, for example, corresponding data 120 that represents the process and the system call in association with each other so that the user may refer thereto. The corresponding data 120 represents, for example, the system call “syscall-A” and VM1 in association with each other. The corresponding data 120 represents, for example, the system call “syscall-B” and VM1 in association with each other. The corresponding data 120 represents, for example, the system call “syscall-C” and VM2 in association with each other.

Thus, the monitoring device 100 may make it easy to identify the factor that has caused the system call of the host OS. For example, the monitoring device 100 may enable the VM that implements one of the execution environments to be identified, as the factor that has caused the system call of the host OS, and may enable the bottleneck of the file access processing to be easily found. The monitoring device 100 may enable the factor that has caused the system call of the host OS to be identified even if there is a deviation between the clock that the host OS has and the clock that each VM has.

Here, the case where the process that implements the execution environment is the VM has been described, but the present embodiment is not limited to this. For example, there may be a case where the process that implements the execution environment is a container. In this case, the container will operate on the host OS. Furthermore, for example, there may be a case where the process that implements the execution environment is the VM and the container. In this case, the VM and the container will operate on the host OS.

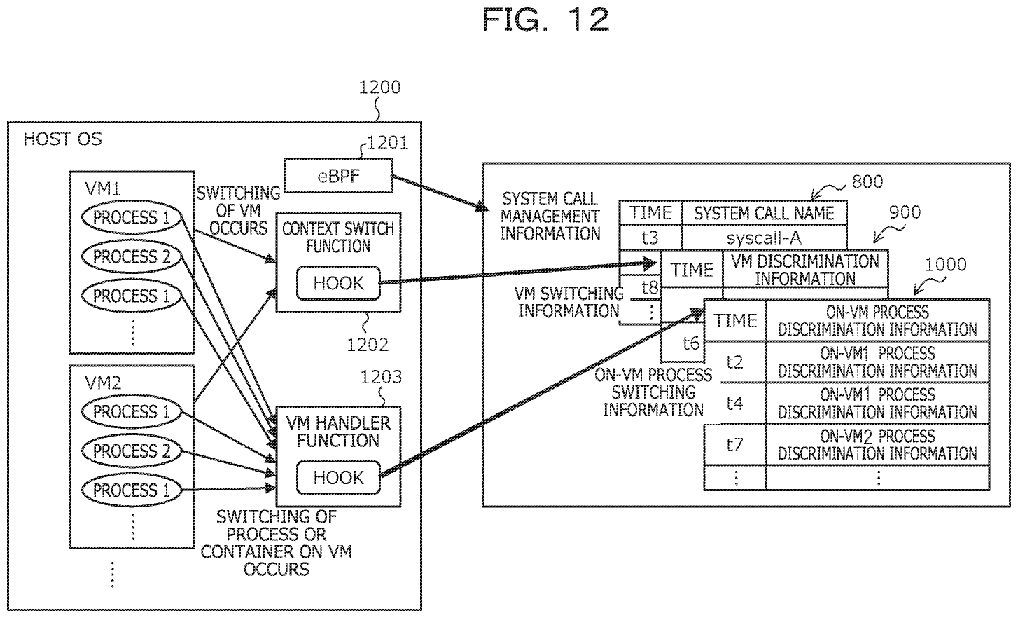

Here, the case where the plurality of processes that each implements the execution environment on the host OS does not have a hierarchical structure has been described, but the present embodiment is not limited to this. For example, there may be a case where the plurality of processes that each implements the execution environment on the host OS has a hierarchical structure. For example, there may be a case where the VM operates on the host OS, and the container operates on the VM. In this case, the monitoring device 100 may output the system call in association with the VM in operation on the host OS at the occurrence time point when the system call has occurred and the container in operation on the VM. Specific examples in this case will be described later with reference to FIGS. 12 to 18.

One Example of Information Processing System

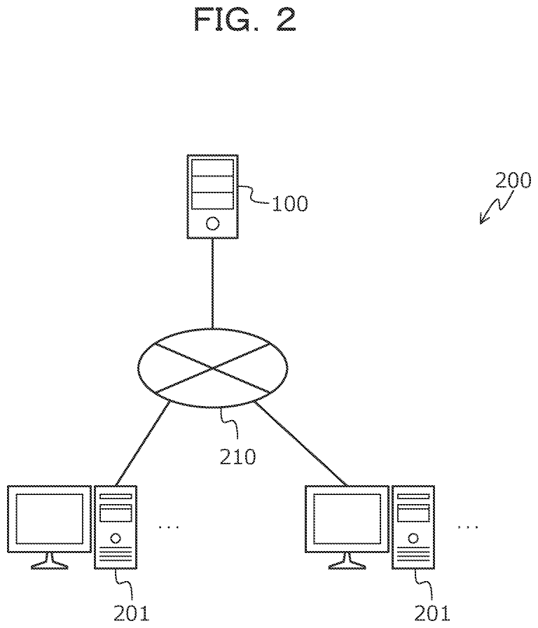

Next, one example of an information processing system 200 to which the monitoring device 100 illustrated in FIG. 1 is applied will be described with reference to FIG. 2.

FIG. 2 is an explanatory diagram illustrating one example of the information processing system 200. In FIG. 2, the information processing system 200 includes a monitoring device 100 and one or more client devices 201.

In the information processing system 200, the monitoring device 100 and the client devices 201 are coupled via a wired or wireless network 210. The network 210 is, for example, a local area network (LAN), a wide area network (WAN), the Internet, or the like.

The monitoring device 100 is a computer that provides a service by using a host OS, a VM, a container, or the like. The service is implemented by the host OS, the VM, the container, and the like. The service is implemented by, for example, a process in the VM or a process in the container calling a system call of the host OS.

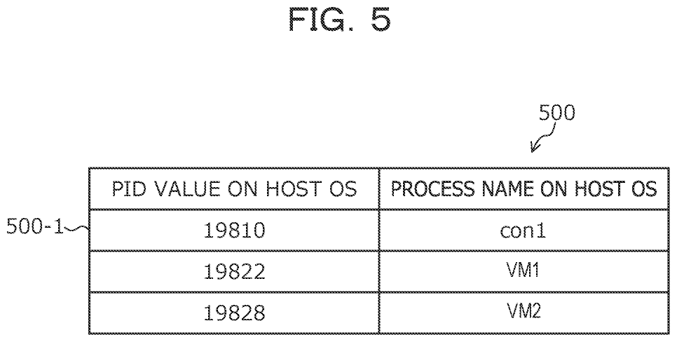

The monitoring device 100 collects a proportional-integral-derivative (PID) value and a VM name of a VM that operates on the host OS and a PID value and a container name of a container that operates on the host OS, and stores the PID values, the VM name, and the container name as first mapping information. The monitoring device 100 collects, on the VM, the VM name of the VM, a PID value and a container name of a container that operates on the VM, and stores the VM name, the PID value, and the container name as second mapping information. The monitoring device 100 collects the PID value and a page table start address of a process managed by a guest OS of the VM, and stores the PID value and the page table start address as third mapping information. For example, the monitoring device 100 stores various types of tables described later in FIGS. 5 to 7.

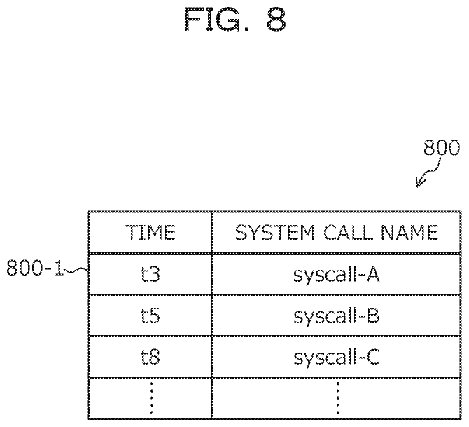

The monitoring device 100 records the occurrence time point when the system call of the host OS has occurred by using a monitor function of the host OS. The monitor function is, for example, an eBPF function. The monitoring device 100 uses, for example, the monitor function of the host OS to collect a system call name and a host time measured by the clock that the host OS has at a call port of the system call of the host OS. The monitoring device 100 stores, for example, the collected system call name and the collected host time in association with each other. For example, the monitoring device 100 stores the collected system call name and the host time in association with each other in a system call management table 800 described later with reference to FIG. 8.

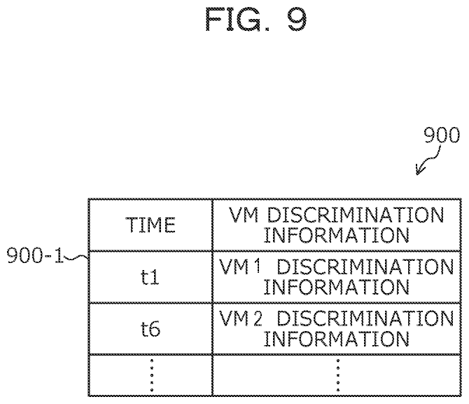

The monitoring device 100 sets a hook in a context switch function of the host OS, and collects a PID value of a process that operates on the host OS and a host time measured by the clock that the host OS has, by using the set hook. The monitoring device 100 stores the collected PID value and the collected host time in association with each other in a VM switching information management table 900 described later with reference to FIG. 9.

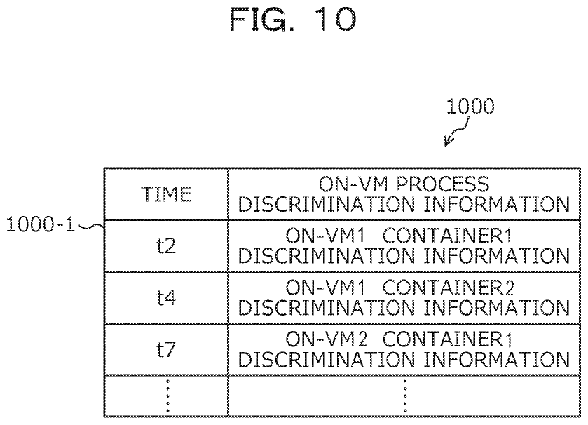

The monitoring device 100 sets a hook in a VM handler function of the host OS, and collects VM exit information, discrimination information that discriminates a process that operates on the VM, and a host time measured by the clock that the host OS has, by using the set hook. The discrimination information is, for example, a page table start address. The monitoring device 100 determines whether or not a process on a VM has switched on the basis of the VM exit information. When it is determined that the switch has been made, the monitoring device 100 stores the collected discrimination information and the collected host time in association with each other in an on-VM process switching information management table 1000, which will be described later with reference to FIG. 10.

The monitoring device 100 identifies a PID value of a process that operates on the host OS and discrimination information that discriminates the process that operates on the VM, which corresponds to a system call name, on the basis of various tables described later with reference to FIGS. 8 to 10. The monitoring device 100 identifies a VM name corresponding to the identified PID value and a process name corresponding to the identified discrimination information, on the basis of various types of tables described later with reference to FIGS. 5 to 8.

The monitoring device 100 adds a suffix to the system call name on the basis of the identified VM name and the identified process name. The monitoring device 100 outputs a result of the addition so that the user may refer thereto. The monitoring device 100 is, for example, a server, a personal computer (PC), or the like.

The client device 201 is a computer that uses the service. The client device 201 is capable of communicating with the monitoring device 100. When the client device 201 uses the service, a system call of the host OS may occur in the monitoring device 100. For example, the client device 201 is a server, a PC, or the like.

Here, the case where the information processing system 200 includes one monitoring device 100 has been described, but the present embodiment is not limited to this. For example, there may be a case where the information processing system 200 includes a plurality of monitoring devices 100. In this case, the plurality of monitoring devices 100 work in cooperation to add a suffix to a system call name.

Specific Example of Information Processing System

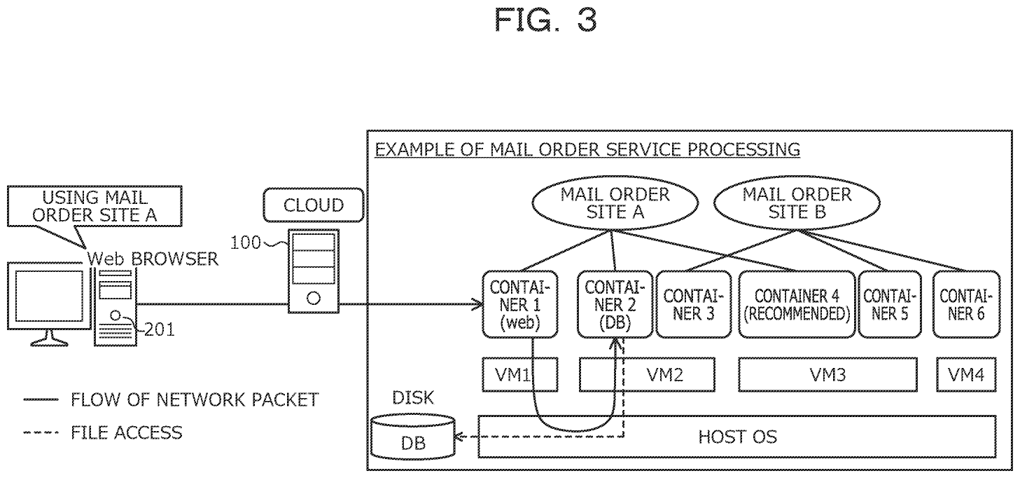

Next, a specific example of the information processing system 200 illustrated in FIG. 2 will be described with reference to FIG. 3.

FIG. 3 is an explanatory diagram illustrating a specific example of the information processing system 200 illustrated in FIG. 2. In FIG. 3, the monitoring device 100 provides, for example, a mail-order service. The client device 201 uses a web browser to use a mail-order service. For example, the monitoring device 100 implements a mail-order site A and a mail-order site B.

The mail-order site A is implemented by a container container1 that operates on a VM VM1 that operates on the host OS, a container container2 that operates on a VM VM2 that operates on the host OS, and a container 4 that operates on a VM VM3 that operates on the host OS. The mail-order site B is implemented by container3 that operates on VM2 that operates on the host OS, a container 5 that operates on VM3 that operates on the host OS, and a container 6 that operates on a VM VM4 that operates on the host OS.

When the mail-order service is used, the monitoring device 100 implements various types of processing of the mail-order service by using a system call of the host OS. The monitoring device 100 implements network processing from container1 to container2, for example, by using a system call of the host OS. The monitoring device 100 implements file access processing of container2, for example, by using a system call of the host OS.

Furthermore, the monitoring device 100 identifies a VM and a container corresponding to a system call of the host OS that has occurred. The monitoring device 100 outputs a system call name of the system call of the host OS, a VM name of the identified VM, and a container name of the identified container in association with each other. Thus, the monitoring device 100 may make it easy to identify a factor that has caused the system call of the host OS.

Hardware Configuration Example of Monitoring Device

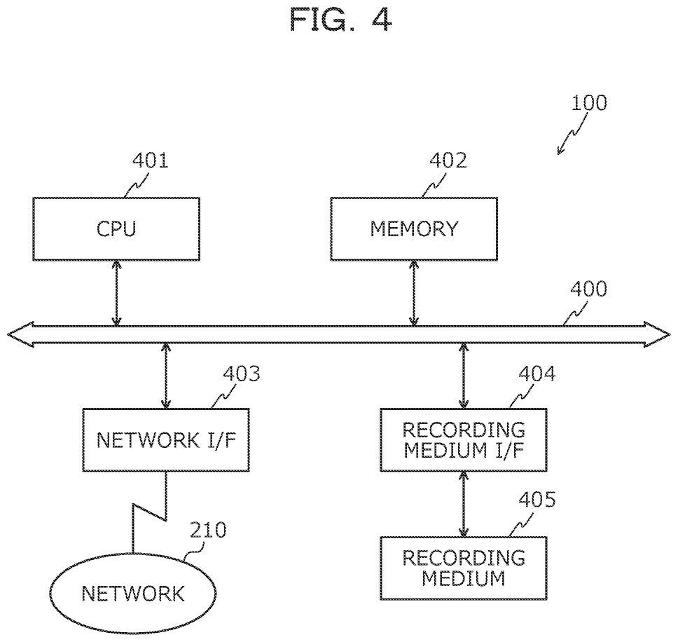

Next, a hardware configuration example of the monitoring device 100 will be described with reference to FIG. 4.

FIG. 4 is a block diagram illustrating a hardware configuration example of the monitoring device. In FIG. 4, the monitoring device 100 includes a central processing unit (CPU) 401, a memory 402, a network interface (I/F) 403, a recording medium I/F 404, and a recording medium 405. The individual components are coupled to each other by a bus 400.

Here, the CPU 401 performs overall control of the monitoring device 100. The memory 402 has, for example, a read only memory (ROM), a random access memory (RAM), a flash ROM, and the like. For example, the flash ROM or the ROM stores various types of programs, while the RAM is used as a work area for the CPU 401. The programs stored in the memory 402 are loaded into the CPU 401 to cause the CPU 401 to execute coded processing.

The network I/F 403 is coupled to the network 210 through a communication line, and is coupled to another computer through the network 210. Then, the network I/F 403 manages an interface between the network 210 and an inside, and controls input and output of data to and from another computer. For example, the network I/F 403 is a modem, a LAN adapter, or the like.

The recording medium I/F 404 controls reading and writing of data from and to the recording medium 405 under the control of the CPU 401. For example, the recording medium I/F 404 is a disk drive, a solid state drive (SSD), a universal serial bus (USB) port, or the like. The recording medium 405 is a nonvolatile memory that stores data written under the control of the recording medium I/F 404. For example, the recording medium 405 is a disk, a semiconductor memory, a USB memory, or the like. The recording medium 405 may be attachable to and detachable from the monitoring device 100.

The monitoring device 100 may have, for example, a keyboard, a mouse, a display, a printer, a scanner, a microphone, a speaker, and the like in addition to the above-described configuration units. Further, the monitoring device 100 may have a plurality of the recording medium I/Fs 404 and a plurality of the recording media 405. Furthermore, the monitoring device 100 does not have to include the recording medium I/F 404 and the recording medium 405.

Content Stored in First Mapping Information Management Table

Next, one example of content stored in a first mapping information management table 500 will be described with reference to FIG. 5. The first mapping information management table 500 is implemented by a storage area of the memory 402, the recording medium 405, or the like of the monitoring device 100 illustrated in FIG. 4, for example.

FIG. 5 is an explanatory diagram illustrating one example of content stored in the first mapping information management table 500. As illustrated in FIG. 5, the first mapping information management table 500 has fields for a PID value on the host OS and a process name on the host OS. In the first mapping information management table 500, the first mapping information is stored as a record 500-1 by setting information in each field for each process.

In the field of the PID value on the host OS, a PID value that discriminates a VM or a container among processes that operate on the host OS is set. In the field of the process name on the host OS, a VM name that discriminates a VM among the processes that operate on the host OS or a container name that discriminates a container among the processes that operate on the host OS is set.

Content Stored in Second Mapping Information Management Table

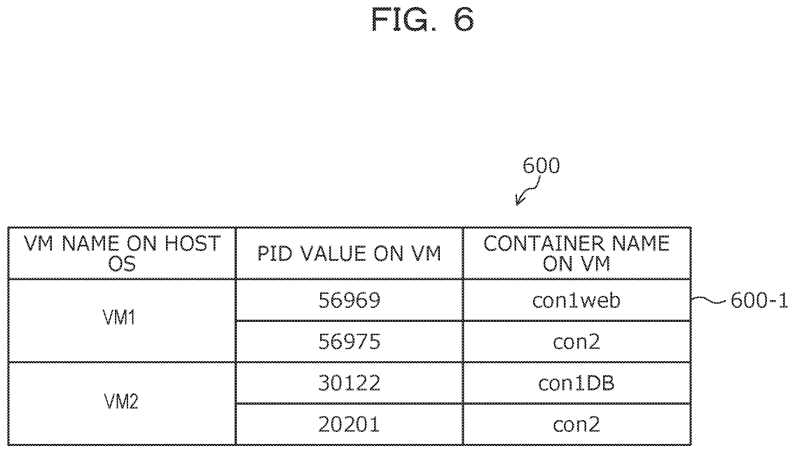

Next, one example of content stored in a second mapping information management table 600 will be described with reference to FIG. 6. The second mapping information management table 600 is implemented by a storage area of the memory 402, the recording medium 405, or the like of the monitoring device 100 illustrated in FIG. 4, for example.

FIG. 6 is an explanatory diagram illustrating one example of content stored in the second mapping information management table 600. As illustrated in FIG. 6, the second mapping information management table 600 has fields of a VM name on the host OS, a PID value on the VM, and a container name on the VM. In the second mapping information management table 600, the second mapping information is stored as a record 600-1 by setting information in each field for each container.

In the field of the VM name on the host OS, a VM name that discriminates a VM that operates on the host OS is set. In the field of the PID value on the VM, a PID value that discriminates a container that operates as a process on the VM described above is set. In the field of the container name on the VM, a container name that discriminates the container that operates as a process on the VM described above is set.

Content Stored in Third Mapping Information Management Table

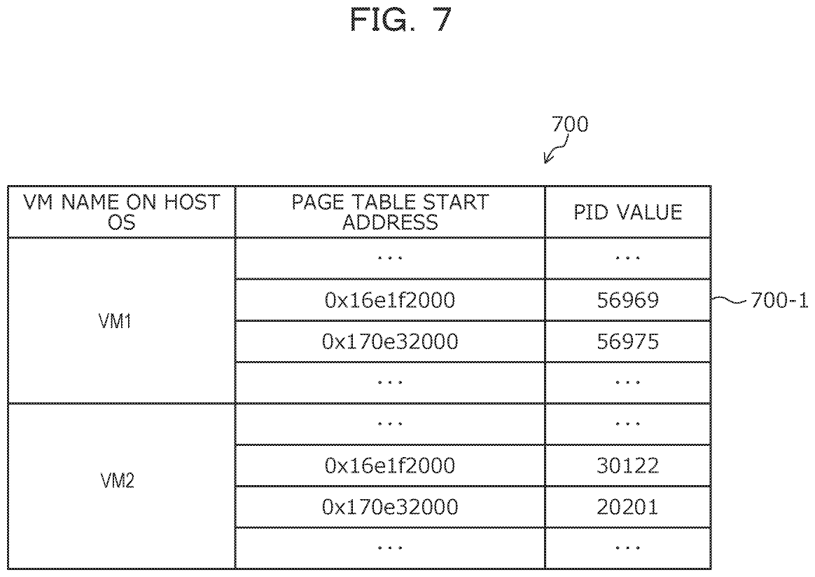

Next, one example of content stored in a third mapping information management table 700 will be described with reference to FIG. 7. The third mapping information management table 700 is implemented by a storage area of the memory 402, the recording medium 405, or the like of the monitoring device 100 illustrated in FIG. 4, for example.

FIG. 7 is an explanatory diagram illustrating one example of content stored in the third mapping information management table 700. As illustrated in FIG. 7, the third mapping information management table 700 has fields of a VM name on the host OS, a page table start address on the VM, and a PID value on the VM. In the third mapping information management table 700, the third mapping information is stored as a record 700-1 by setting information in each field for each process.

In the field of the VM name on the host OS, a VM name that discriminates a VM that operates on the host OS is set. In the field of the page table start address, a page table start address corresponding to a process that operates on the VM described above is set. In the field of the PID value, a PID value that discriminates the process described above is set.

Content Stored in System Call Management Table

Next, one example of content stored in the system call management table 800 will be described with reference to FIG. 8. The system call management table 800 is implemented by a storage area of the memory 402, the recording medium 405, or the like of the monitoring device 100 illustrated in FIG. 4, for example.

FIG. 8 is an explanatory diagram illustrating one example of the content stored in the system call management table 800. As illustrated in FIG. 8, the system call management table 800 has fields of a time and a system call name. In the system call management table 800, system call management information is stored as a record 800-1 by setting information in each field for each system call.

In the field of the time, a time when a system call has occurred is set. The time is, for example, the time measured by the clock that the host OS has. A system call name that discriminates the system call described above is set in the field of the system call name.

Content Stored in VM Switching Information Management Table

Next, one example of content stored in a VM switching information management table 900 will be described with reference to FIG. 9. The VM switching information management table 900 is implemented by a storage area of the memory 402, the recording medium 405, or the like of the monitoring device 100 illustrated in FIG. 4, for example.

FIG. 9 is an explanatory diagram illustrating one example of content stored in the VM switching information management table 900. As illustrated in FIG. 9, the VM switching information management table 900 has fields of a time and VM discrimination information. In the VM switching information management table 900, VM switching information is stored as a record 900-1 by setting information in each field for each VM.

In the field of the time, a time when a certain VM has switched from a non-operating state to an operating state on the host OS is set. The non-operating state includes a state before it is not operating yet. The time is, for example, a time measured by the clock that the host OS has. In the field of the VM discrimination information, a PID value is set as VM discrimination information that discriminates the VM described above.

Content Stored in On-VM Process Switching Information Management Table

Next, one example of content stored in an on-VM process switching information management table 1000 will be described with reference to FIG. 10. The on-VM process switching information management table 1000 is implemented by a storage area of the memory 402, the recording medium 405, or the like of the monitoring device 100 illustrated in FIG. 4, for example.

FIG. 10 is an explanatory diagram illustrating one example of content stored in the on-VM process switching information management table 1000. As illustrated in FIG. 10, the on-VM process switching information management table 1000 has fields of a time and on-VM process discrimination information. In the on-VM process switching information management table 1000, on-VM process switching information is stored as a record 1000-1 by setting information in each field for each process.

In the field of the time, a time when a certain process has switched from a non-operating state to an operating state on the VM is set. The time is, for example, a time measured by the clock that the host OS has. In the field of the on-VM process discrimination information, a PID value is set as on-VM process discrimination information that discriminates the process described above. In the field of the on-VM process discrimination information, a page table start address may be set as the on-VM process discrimination information that discriminates the process described above.

Hardware Configuration Example of Client Device

Since a hardware configuration example of the client device 201 is similar to, for example, the hardware configuration example of the monitoring device 100 illustrated in FIG. 4, the description thereof will be omitted.

Functional Configuration Example of Monitoring Device

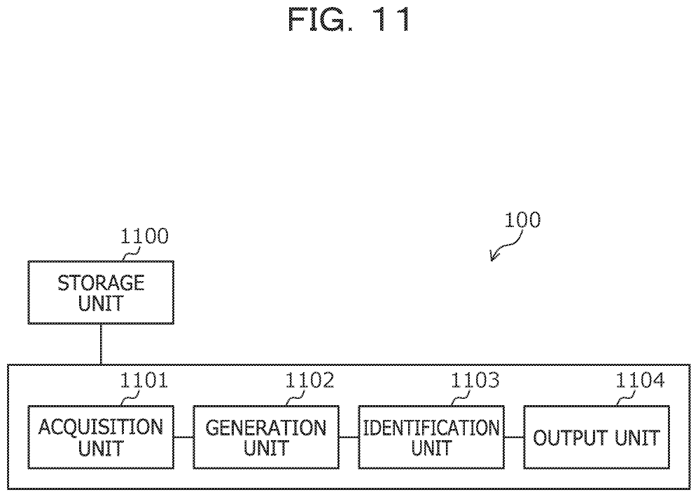

Next, a functional configuration example of the monitoring device 100 will be described with reference to FIG. 11.

FIG. 11 is a block diagram illustrating a functional configuration example of the monitoring device 100. The monitoring device 100 includes a storage unit 1100, an acquisition unit 1101, a generation unit 1102, an identification unit 1103, and an output unit 1104.

The storage unit 1100 is implemented by a storage area of the memory 402, the recording medium 405, or the like illustrated in FIG. 4, for example. Hereinafter, a case in which the storage unit 1100 is included in the monitoring device 100 will be described, but the present embodiment is not limited to this. For example, there may be a case where the storage unit 1100 is included in a device different from the monitoring device 100, and content stored in the storage unit 1100 is allowed to be referred to by the monitoring device 100.

The acquisition unit 1101 to the output unit 1104 function as one example of a control unit. For example, functions of the acquisition unit 1101 to the output unit 1104 are implemented by causing the CPU 401 to execute a program stored in the storage area of the memory 402, the recording medium 405, or the like or by the network I/F 403, which are illustrated in FIG. 4. The acquisition unit 1101 to the output unit 1104 are implemented, for example, on the host OS. A processing result of each functional unit is stored in the storage area of the memory 402, the recording medium 405, or the like illustrated in FIG. 4, for example.

The storage unit 1100 stores various types of information to be referred to or updated in the processing of each functional unit. The storage unit 1100 stores an occurrence time point when a system call of the host OS has occurred. When the monitoring device 100 includes a plurality of arithmetic units, the storage unit 1100 stores the occurrence time point when the system call of the host OS has occurred for each arithmetic unit. The storage unit 1100 stores, for example, the occurrence time point when the system call of the host OS has occurred in the system call management table 800. The occurrence time point is, for example, detected by the acquisition unit 1101 or identified by the generation unit 1102.

The storage unit 1100 stores operation information that enables a switching time point to be identified. The switching time point is a time point when a process that implements an execution environment, which is isolated from the host OS and in operation on the host OS, has switched. The process is, for example, a VM or a container. When the monitoring device 100 includes a plurality of arithmetic units, the storage unit 1100 stores, for each arithmetic unit, the operation information that enables the switching time point to be identified. The operation information is, for example, acquired by the acquisition unit 1101 or generated by the generation unit 1102.

The storage unit 1100 stores first operation information that enables a first switching time point to be identified. The first switching time point is a time point when a VM in operation on the host OS has switched. When the monitoring device 100 includes a plurality of arithmetic units, the storage unit 1100 stores the first operation information that enables the first switching time point to be identified, for each arithmetic unit. For example, the storage unit 1100 stores, in the VM switching information management table 900, the first operation information that enables the first switching time point to be identified. The first operation information is, for example, acquired by the acquisition unit 1101 or is generated by the generation unit 1102.

The storage unit 1100 stores second operation information that enables a second switching time point to be identified. The second switching time point is a time point when a container in operation on a VM in operation on the host OS has switched. In the following explanation, on the VM in operation on the host OS, a time point when a container in operation has switched is described as the “second switching time point”, and a time point when a process in operation has switched is described as a “fourth switching time point”, so as to distinguish the time points. This process may be limited to other than the VM and the container. When the monitoring device 100 includes a plurality of arithmetic units, the storage unit 1100 stores the second operation information that enables the second switching time point to be identified, for each arithmetic unit. For example, the storage unit 1100 stores, in the on-VM process switching information management table 1000, the second operation information that enables the second switching time point to be identified. The second operation information is, for example, acquired by the acquisition unit 1101 or is generated by the generation unit 1102.

The storage unit 1100 stores third operation information that enables a third switching time point to be identified. The third switching time point is a time point when a process in operation on the host OS has switched. The third operation information may include, for example, the first operation information. The process may be other than a VM and a container. When the monitoring device 100 includes a plurality of arithmetic units, the storage unit 1100 stores the third operation information that enables the third switching time point to be identified, for each arithmetic unit. For example, the storage unit 1100 stores, in the VM switching information management table 900, the third operation information that enables the third switching time point to be identified. The third operation information is, for example, acquired by the acquisition unit 1101 or is generated by the generation unit 1102.

The storage unit 1100 stores fourth operation information that enables a fourth switching time point to be identified. The fourth switching time point is a time point when a process in operation on a VM in operation on the host OS has switched. The process may be other than a VM and a container. The fourth operation information may include, for example, the second operation information. When the monitoring device 100 includes a plurality of arithmetic units, the storage unit 1100 stores the fourth operation information that enables the fourth switching time point to be identified, for each arithmetic unit. For example, the storage unit 1100 stores, in the on-VM process switching information management table 1000, the fourth operation information that enables the fourth switching time point to be identified. The fourth operation information is, for example, acquired by the acquisition unit 1101 or is generated by the generation unit 1102.

The acquisition unit 1101 acquires various types of information to be used for the processing of each functional unit. The acquisition unit 1101 stores the acquired various types of information in the storage unit 1100 or outputs the acquired various types of information to each functional unit. Furthermore, the acquisition unit 1101 may output the various types of information stored in the storage unit 1100 to each functional unit. The acquisition unit 1101 acquires the various types of information on the basis of, for example, an operation input by a user. The acquisition unit 1101 may receive the various types of information from a device different from the monitoring device 100, for example.

The acquisition unit 1101 acquires an occurrence time point when a system call of the host OS has occurred by detecting the occurrence time point. When the monitoring device 100 includes a plurality of arithmetic units, the acquisition unit 1101 detects the occurrence time point, for each arithmetic unit. The acquisition unit 1101 detects that a system call of the host OS has occurred by using, for example, a monitor function of the host OS. The monitor function is, for example, an eBPF function. Then, the acquisition unit 1101 acquires, for example, a time point measured by the clock that the host OS has at the time of detection as the occurrence time point when the detected system call of the host OS has occurred. The acquisition unit 1101 may acquire, for example, the occurrence time point by receiving the occurrence time point from another computer.

The acquisition unit 1101 acquires operation information that enables a switching time point to be identified. The switching time point is a time point when a process that implements an execution environment isolated from the host OS has switched. When the monitoring device 100 includes a plurality of arithmetic units, the acquisition unit 1101 acquires the operation information that enables the switching time point to be identified, for each arithmetic unit. The acquisition unit 1101 acquires the operation information that enables the switching time point to be identified, for example, by receiving the operation information from another computer.

The acquisition unit 1101 acquires the first operation information. The acquisition unit 1101 acquires, for example, the first operation information by receiving the first operation information from another computer.

The acquisition unit 1101 acquires information that enables the generation unit 1102 to generate the first operation information. For example, the acquisition unit 1101 detects that a process in operation on the host OS has switched to a certain VM by using a first function that operates when switching a process in operation on the host OS. Then, a result of the detection is transmitted to the generation unit 1102. The first function is, for example, a context switch function of the host OS. For example, the acquisition unit 1101 sets a hook in the context switch function of the host OS. Then, the acquisition unit 1101, for example, detects that the process in operation on the host OS has switched to the certain VM by using the set hook.

The acquisition unit 1101 acquires the second operation information. The acquisition unit 1101 acquires, for example, the second operation information by receiving the second operation information from another computer.

The acquisition unit 1101 acquires information that enables the generation unit 1102 to generate the second operation information. For example, by using a second function that operates when control transfer is performed from a VM to the host OS, the acquisition unit 1101 detects a container in operation on the VM immediately before the control transfer, and transmits a result of the detection to the generation unit 1102. The second function is, for example, a VM handler function of the host OS. For example, the acquisition unit 1101 sets a hook in the VM handler function of the host OS. Then, the acquisition unit 1101, for example, detects the container in operation on the VM immediately before the control transfer by using the set hook.

The acquisition unit 1101 acquires the third operation information. The acquisition unit 1101 acquires, for example, the third operation information by receiving the third operation information from another computer.

The acquisition unit 1101 acquires information that enables the generation unit 1102 to generate the third operation information. For example, the acquisition unit 1101 detects that a process in operation on the host OS has switched by using a third function that operates when a process in operation on the host OS has switched, and transmits a result of the detection to the generation unit 1102. The third function is, for example, a context switch function of the host OS. For example, the acquisition unit 1101 sets a hook in the context switch function of the host OS. Then, the acquisition unit 1101, for example, detects that the process in operation on the host OS has switched by using the set hook.

The acquisition unit 1101 acquires the fourth operation information. The acquisition unit 1101 acquires, for example, the fourth operation information by receiving the fourth operation information from another computer.

The acquisition unit 1101 acquires information that enables the generation unit 1102 to generate the fourth operation information. For example, by using a fourth function that operates when control transfer is performed from a VM to the host OS, the acquisition unit 1101 detects a process in operation on the VM immediately before the control transfer, and transmits a result of the detection to the generation unit 1102. The fourth function is, for example, a VM handler function of the host OS. For example, the acquisition unit 1101 sets a hook in the VM handler function of the host OS. Then, the acquisition unit 1101, for example, detects the process in operation on the VM immediately before the control transfer by using the set hook.

The acquisition unit 1101 acquires a resource usage status of a process that implements an execution environment isolated from the host OS, and transmits the acquired resource usage status to the generation unit 1102. The resource usage status is, for example, a resource usage amount. The resource is, for example, a CPU, a memory, or a network bandwidth, or the like. The acquisition unit 1101 acquires, for example, the CPU usage rate of a VM or a container that operates on the host OS.

The acquisition unit 1101 detects that a waiting time has occurred in the process that implements the execution environment isolated from the host OS, and transmits a result of the detection to the generation unit 1102. The waiting time is caused by a steal. The acquisition unit 1101 detects that a waiting time has occurred because the VM has been deprived of the right to use the CPU by another VM.

The acquisition unit 1101 may receive a start trigger to start processing of any one of the functional units. The start trigger is, for example, a predetermined operation input made by the user. The start trigger may be, for example, a receipt of predetermined information from another computer. The start trigger may be, for example, an output of predetermined information by any one of the functional units.

The acquisition unit 1101 may receive, as a start trigger to start processing of the generation unit 1102, information that enables generation of the first operation information, the second operation information, the third operation information, or the fourth operation information. The acquisition unit 1101 may receive, as a start trigger to start processing of the identification unit 1103, a predetermined operation input by the user.

The generation unit 1102 generates the first operation information by associating a VM detected by the acquisition unit 1101 with a time point measured by the host OS. Thus, the generation unit 1102 may make the first switching time point when the VM has switched from a non-operating state to an operating state on the host OS available to the identification unit 1103.

The generation unit 1102 generates the second operation information by associating a container detected by the acquisition unit 1101 with a time point measured by the host OS. Thus, the generation unit 1102 may make the second switching time point when the container has switched from a non-operating state to an operating state on the VM that operates on the host OS available to the identification unit 1103.

The generation unit 1102 generates the third operation information by associating a process detected by the acquisition unit 1101 with a time point measured by the host OS. Thus, the generation unit 1102 may make the third switching time point at which the process has switched from a non-operating state to an operating state on the host OS available to the identification unit 1103.

The generation unit 1102 generates the fourth operation information by associating a process detected by the acquisition unit 1101 with a time point measured by the host OS. Thus, the generation unit 1102 may make the fourth switching time point when the process has switched from a non-operating state to an operating state on the VM that operates on the host OS available to the identification unit 1103.

The generation unit 1102 identifies an occurrence time point when the system call of the host OS has occurred for a process of which a resource usage status acquired by the acquisition unit 1101 satisfies a condition. For example, the condition is set in consideration of which factor that has caused the system call is preferable to be easy to identify from the viewpoint of finding the bottleneck. The condition is, for example, that a CPU usage rate exceeds a threshold. For example, it is considered preferable, from the viewpoint of finding the bottleneck, to make it easy to identify the factor that has caused the system call that satisfies the condition.

For example, the generation unit 1102 identifies the occurrence time point when the system call related to the VM whose CPU usage rate acquired by the acquisition unit 1101 exceeds the threshold has occurred among the system calls that have occurred, and transmits the identified occurrence time point to the identification unit 1103. Thus, the generation unit 1102 may set a part of the generated system calls as a processing target of the identification unit 1103, and may reduce the processing amount of the identification unit 1103. Furthermore, the generation unit 1102 may enable the factor to be identified while reducing the processing amount of the identification unit 1103, the factor having caused one of the system calls that is likely to be useful from the viewpoint of finding the bottleneck by the identification unit 1103.

The generation unit 1102 detects an occurrence time point when a system call of the host OS has occurred with respect to a process in which a waiting time detected by the acquisition unit 1101 has occurred. A system call in which a waiting time has occurred has a relatively high probability of being a system call related to the bottleneck. Thus, it is considered preferable from the viewpoint of finding the bottleneck point to make it easy to identify the factor that has caused the system call in which a waiting time has occurred.

The generation unit 1102 identifies an occurrence time point when a system call related to a VM in which a waiting time detected by the acquisition unit 1101 has occurred among the system calls that have occurred, and transmits the identified occurrence time point to the identification unit 1103. Thus, the generation unit 1102 may set a part of the generated system calls as a processing target of the identification unit 1103, and may reduce the processing amount of the identification unit 1103. Furthermore, the generation unit 1102 may enable the factor to be identified while reducing the processing amount of the identification unit 1103, the factor having caused one of the system calls that is likely to be useful from the viewpoint of finding the bottleneck by the identification unit 1103.

On the basis of the acquired operation information, the identification unit 1103 identifies a process that implements one of the execution environments in operation on the host OS at the detected occurrence time point. For example, the identification unit 1103 identifies a VM in operation on the host OS at the detected occurrence time point on the basis of the acquired first operation information. For example, when the monitoring device 100 includes a plurality of arithmetic units, the identification unit 1103 identifies a VM in operation on the host OS at the detected occurrence time point, for each arithmetic unit. Thus, the identification unit 1103 may identify a VM that is a candidate for the factor that has caused the system call.

For example, the identification unit 1103 identifies a VM in operation on the host OS and a container in operation on the VM at the detected occurrence time point on the basis of the acquired first operation information and the acquired second operation information. For example, when the monitoring device 100 includes a plurality of arithmetic units, the identification unit 1103 identifies a VM in operation on the host OS and a container in operation on the VM at the detected occurrence time point, for each arithmetic unit. Thus, the identification unit 1103 may identify a combination of a VM and a container that operates on the VM, which are candidates for the factor that has caused the system call.

For example, the identification unit 1103 identifies a process in operation on the host OS at the detected occurrence time point on the basis of the acquired third operation information. For example, when the monitoring device 100 includes a plurality of arithmetic units, the identification unit 1103 identifies a process in operation on the host OS at the detected occurrence time point, for each arithmetic unit. Thus, the identification unit 1103 may identify a process that is a candidate for the factor that has caused the system call.

For example, the identification unit 1103 identifies, on the basis of the acquired first operation information and the acquired fourth operation information, a VM in operation on the host OS and a process in operation on the VM at the detected occurrence time point. For example, when the monitoring device 100 includes a plurality of arithmetic units, the identification unit 1103 identifies a VM in operation on the host OS and a process in operation on the VM at the detected occurrence time point, for each arithmetic unit. Thus, the identification unit 1103 may identify a combination of a VM and a process that operates on the VM, which are candidates for the factor that has caused the system call.

The output unit 1104 outputs a processing result of at least one of the functional units. An output format is, for example, display on a display, print output to a printer, transmission to an external device by the network I/F 403, or storage in the storage area of the memory 402, the recording medium 405, or the like. Thus, the output unit 1104 may notify the user of the processing result of at least one of the functional units, and enhancement of convenience of the monitoring device 100 may be achieved.

The output unit 1104 outputs the identified process that implements one of the execution environments in association with the system call. The output unit 1104 outputs, for example, the identified VM in association with the system call. For example, the output unit 1104 outputs the identified VM in association with the system call so that the user may refer thereto. Thus, the output unit 1104 may enable the user to grasp the VM that is a candidate for the factor that has caused the system call, and may make it easy to identify the factor that has caused the system call.

The output unit 1104 outputs, for example, the identified VM and the identified container in association with the system call. For example, the output unit 1104 outputs the identified VM and the identified container in association with the system call so that the user may refer thereto. Thus, the output unit 1104 may enable the user to grasp the combination of the VM and the container, which are candidates for the factor that has caused the system call, and make it easy to identify the factor that has caused the system call.

The output unit 1104 outputs, for example, the identified process in association with the system call. For example, the output unit 1104 outputs the identified process in association with the system call so that the user may refer thereto. Thus, the output unit 1104 may enable the user to grasp the process that is a candidate for the factor that has caused the system call, and may make it easy to identify the factor that has caused the system call.

The output unit 1104 outputs, for example, the identified VM and the identified process in association with the system call. For example, the output unit 1104 outputs the identified VM and the identified process in association with the system call so that the user may refer thereto. Thus, the output unit 1104 may enable the user to grasp the combination of the VM and the process, which are candidates for the factor that has caused the system call, and make it easier to identify the factor that has caused the system call.

On the basis of the acquired third operation information, the output unit 1104 may determine whether or not the process in operation on the host OS at the detected occurrence time point is the process that implements the execution environment isolated from the host OS. Then, upon determining that the process in operation on the host OS is not the process that implements the execution environment isolated from the host OS at the detected occurrence time point, the output unit 1104 may output the host OS in association with the system call. Thus, the output unit 1104 may enable the factor that has caused the system call to be easily identified.

One Example of Operation of Monitoring Device

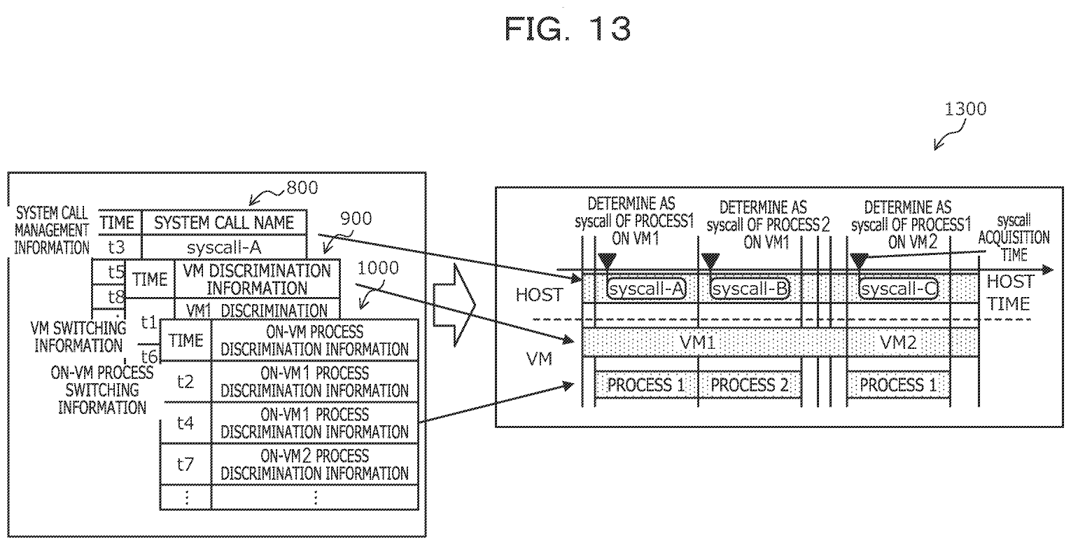

Next, one example of operation of the monitoring device 100 will be described with reference to FIGS. 12 and 13.

FIGS. 12 and 13 are explanatory diagrams illustrating one example of the operation of the monitoring device 100. In FIG. 12, the monitoring device 100 has a host OS 1200. The host OS 1200 has an eBPF function 1201. VM1 and VM2 operate while switching to each other on the host OS 1200. The host OS 1200 has a context switch function 1202 and a VM handler function 1203.

The host OS 1200 uses the eBPF function 1201 to detect that a system call has occurred. The host OS 1200 generates system call management information in which a system call name of the detected system call is associated with a host time measured by the clock that the host OS has when it is detected, and stores the system call management information in the system call management table 800.

The host OS 1200 sets a hook on the context switch function 1202. The hook specifies, for example, new processing for detecting that a VM has switched to the operating state. The host OS 1200 detects that a VM has switched to the operating state by using the hook set in the context switch function 1202 and acquires a PID value of the VM. The host OS 1200 generates VM switching information in which the acquired PID value is associated with a host time measured by the clock that the host OS has when it is detected, and stores the VM switching information in the VM switching information management table 900.

The host OS 1200 sets a hook in the VM handler function 1203. The hook specifies new processing for detecting that a certain process has switched to the operating state on the VM. The host OS 1200 detects that a certain process has switched to the operating state on the VM by using the hook set in the VM handler function 1203, and acquires discrimination information that discriminates the process. The host OS 1200 generates on-VM process switching information that associates the acquired discrimination information with a host time measured by the clock that the host OS has when it is detected, and stores the on-VM process switching information in the on-VM process switching information management table 1000. Next, the description proceeds to FIG. 13.

In FIG. 13, the host OS 1200 identifies the relation between a system call, a VM, and a process that operates on the VM as illustrated in a graph 1300, on the basis of various types of tables 800 to 1000. The host OS 1200 compares, for example, a host time when a system call has occurred, a host time when a VM has switched to the operating state, and a host time when a process has switched to the operating state on the VM on the time axis of the host time.

Then, the host OS 1200 determines, for example, that a system call “syscall-A” corresponds to a process process1 on VM1 on the basis of a result of the comparison. Furthermore, the host OS 1200 determines, for example, that a system call “syscall-B” corresponds to a process process2 on VM1 on the basis of the result of the comparison. Furthermore, the host OS 1200 determines, for example, that a system call “syscall-C” corresponds to process1 on VM2 on the basis of the result of the comparison.

The host OS 1200 outputs, for example, the determination result so that the user may refer thereto. Thus, the monitoring device 100 may enable the user to grasp which VM the system call of the host OS is related to and which process that operates on which VM the system call of the host OS is related to. In this manner, the monitoring device 100 may make it easy for the user to identify the factor that has caused the system call of the host OS.

Here, the case where the host OS 1200 generates the system call management information every time the host OS 1200 detects that the system call has occurred, and stores the system call management information in the system call management table 800 has been described, but the present embodiment is not limited to this. For example, there may be a case where, upon detecting that a system call has occurred, the host OS 1200 determines whether or not the condition for generating the system call management information is satisfied, and if the condition is satisfied, the system call management information is generated.

For example, there may be a case where the host OS 1200 acquires an index value, such as a CPU usage rate or IO wait of a process, for each process that operates on the host OS 1200, and determines whether or not the acquired index value satisfies the condition. Then, upon detecting that a system call has occurred for a process that satisfies the condition, the host OS 1200 generates the system call management information. Thus, the monitoring device 100 may prevent an overflow of the storage area and reduce the processing amount.

For example, there may be a case where the host OS 1200 determines whether or not a waiting time due to a steal has occurred for each VM that operates on the host OS 1200. Then, upon detecting that a system call has occurred for a VM for which it is determined that a waiting time has occurred, the host OS 1200 generates the system call management information. Furthermore, the host OS 1200 may generate system call management information upon detecting that a system call has occurred for another VM that uses the same CPU as a VM for which it is determined that a waiting time has occurred. Thus, the monitoring device 100 may prevent an overflow of the storage area and reduce the processing amount.

First Specific Example of Operation of Monitoring Device

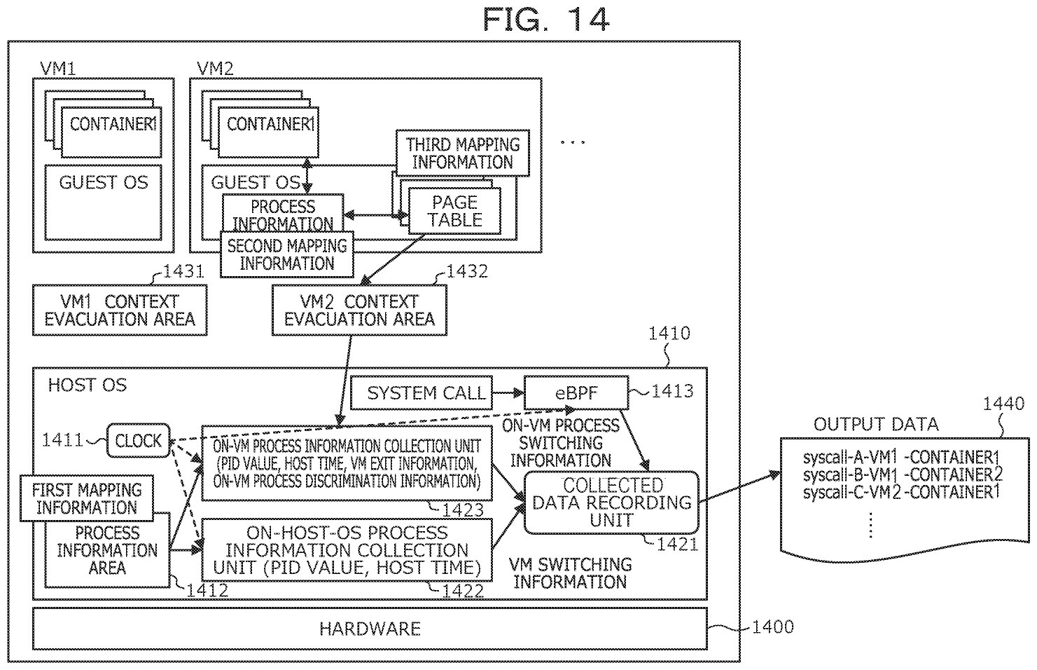

Next, a first specific example of the operation of the monitoring device 100 will be described with reference to FIGS. 14 to 16.

FIGS. 14 to 16 are explanatory diagrams illustrating a first specific example of the operation of the monitoring device 100. In FIG. 14, the monitoring device 100 has a host OS 1410 that operates on hardware 1400. On the host OS 1410, a plurality of VMs operate while switching to each other. On the host OS 1410, for example, VM1 and VM2 operate while switching to each other. Each VM has a guest OS.

The host OS 1410 has a clock 1411, a process information area 1412, and an eBPF function 1413. The host OS 1410 has a collected data recording unit 1421, an on-host-OS process information collection unit 1422, and an on-VM process information collection unit 1423. The monitoring device 100 has, for each VM, a VM context evacuation area corresponding to the VM. The monitoring device 100 has, for example, a VM1 context evacuation area 1431 and a VM2 context evacuation area 1432.

The monitoring device 100 collects the first mapping information, the second mapping information, and the third mapping information, and transmits the first mapping information, the second mapping information, and the third mapping information to the collected data recording unit 1421. The monitoring device 100 collects, for example, PID values of a VM and a container that operate as processes on the host OS 1410. Then, the monitoring device 100 generates, for example, the first mapping information that includes information in which the collected PID value of the VM is associated with a VM name of the VM and information in which the collected PID value of the container is associated with a container name of the container.

The monitoring device 100 causes a PID value and a container name of a container that operates on a VM to be collected in the VM, and causes the second mapping information that includes information in which the collected PID value and container name of the container are associated with a VM name of the VM to be generated in the VM. The monitoring device 100 acquires the generated second mapping information.

The monitoring device 100 causes a page table start address and a PID value of a process managed by a guest OS on a VM to be collected in the VM. The monitoring device 100 causes the third mapping information that includes information in which a VM name of the VM is associated with the page table start address and PID value collected in the VM to be generated in the VM. The monitoring device 100 acquires the generated third mapping information.

The host OS 1410 uses the eBPF function 1413 to detect that a system call has occurred. The host OS 1410 generates a system call management information in which a system call name of the detected system call is associated with a host time measured by the clock 1411 when it is detected, and transmits the system call management information to the collected data recording unit 1421. The collected data recording unit 1421 stores the received system call management information in the system call management table 800.

The on-host-OS process information collection unit 1422 sets a hook in a context switch function. The hook specifies, for example, new processing for detecting that a VM has switched to the operating state. The on-host-OS process information collection unit 1422 detects that a VM has switched to the operating state by using the hook set in the context switch function, and acquires a PID value of the VM. The on-host-OS process information collection unit 1422 generates VM switching information in which a VM name of the VM, the acquired PID value, and a host time measured by the clock 1411 when it is detected are associated with each other, and transmits the VM switching information to the collected data recording unit 1421. The collected data recording unit 1421 stores the received VM switching information in the VM switching information management table 900.

The on-VM process information collection unit 1423 sets a hook in a VM handler function. The hook specifies new processing for detecting that a certain process has switched to the operating state on the VM. The on-VM process information collection unit 1423 detects that a certain process has switched to the operating state on the VM by using the hook set in the VM handler function, and acquires discrimination information that discriminates the process. The on-VM process information collection unit 1423 collects VM exit information and on-VM process discrimination information from a VM context evacuation area by using the hook set in the VM handler function, for example. The on-VM process discrimination information is, for example, a page table start address corresponding to the process on the VM.

For example, the on-VM process information collection unit 1423 collects the VM exit information and the page table start address that is the on-VM process discrimination information from the VM context evacuation area. For example, the on-VM process information collection unit 1423 identifies the PID value corresponding to the collected page table start address on the basis of the third mapping information. For example, the on-VM process information collection unit 1423 acquires the host time measured by the clock 1411 when it is collected.

For example, the on-VM process information collection unit 1423 determines whether or not a factor that has caused control transfer from a VM to the host OS 1410 is switching of a process that operates on the VM on the basis of the collected VM exit information. For example, when an exit reason number included in the VM exit information is 9, the on-VM process information collection unit 1423 determines that the factor that has caused the control transfer from the VM to the host OS 1410 is the switching of the process that operates on the VM.

Here, for example, when it is determined that the switching of the process that operates on the VM is the factor, the on-VM process information collection unit 1423 generates the on-VM process switching information in which a VM name of the VM, the identified PID value, and the acquired host time are associated with each other. For example, the on-VM process information collection unit 1423 transmits the generated on-VM process switching information to the collected data recording unit 1421. On the other hand, for example, when it is determined that the switching of the process that operates on the VM is not the factor, the on-VM process information collection unit 1423 does not generate the on-VM process switching information. The collected data recording unit 1421 stores the received on-VM process switching information in the on-VM process switching information management table 1000.

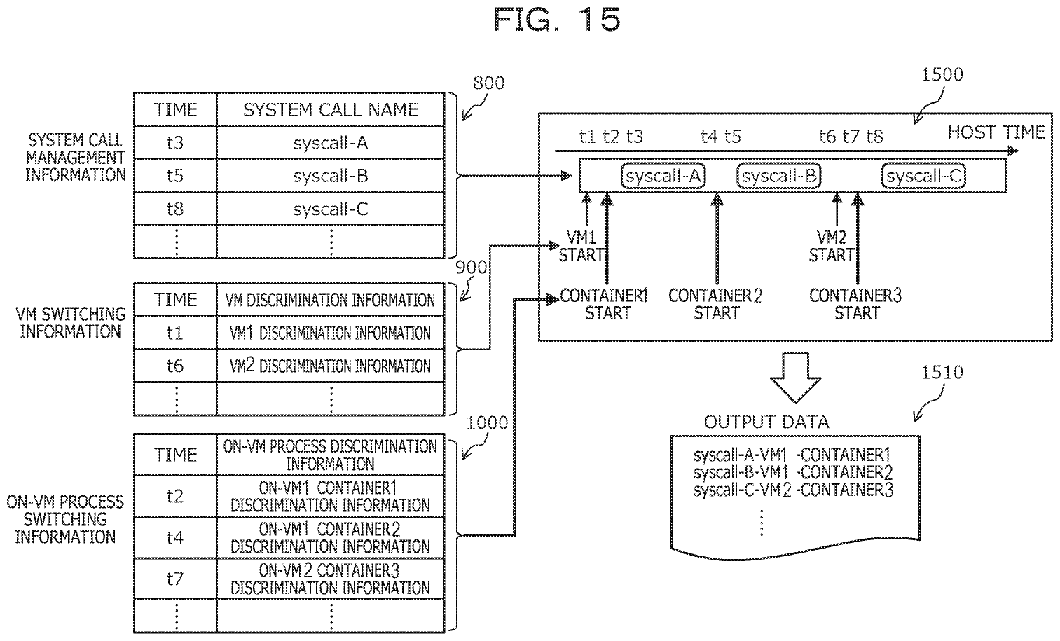

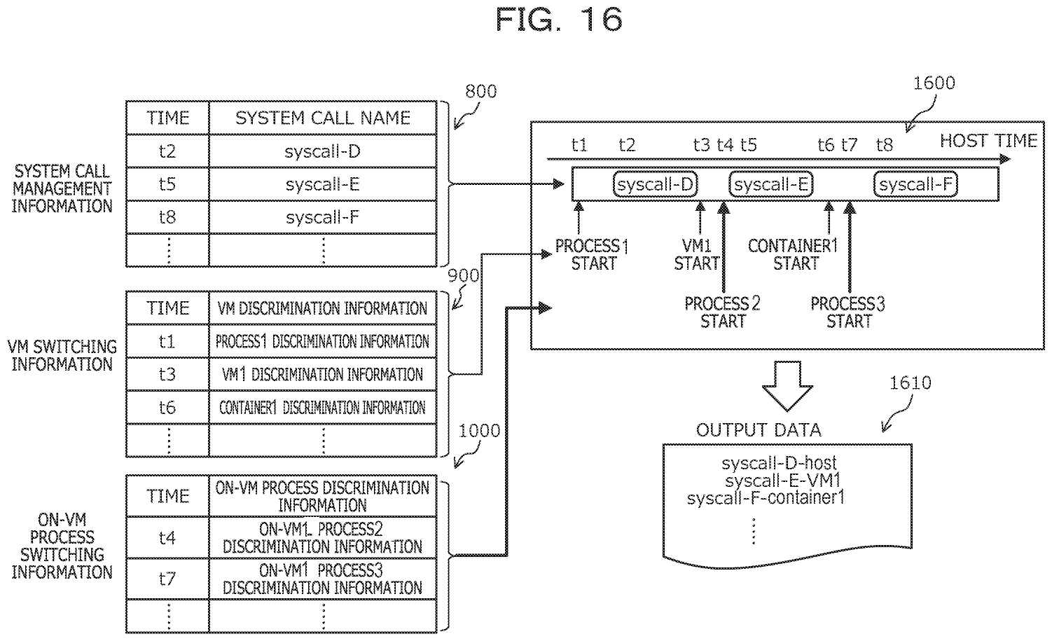

The collected data recording unit 1421 identifies various types of processes corresponding to a system call on the basis of the various types of tables 500 to 1000 illustrated in FIGS. 5-10, and adds a suffix to the system call on the basis of a result of the identification. For example, a specific example in which the collected data recording unit 1421 identifies the various types of process corresponding to system calls will be described later with reference to FIGS. 15 and 16.

The various types of processes corresponding to system calls include, for example, a VM or a container that operates on the host OS 1410, a container that operates on a VM that operates on the host OS 1410, and the like. The various types of processes corresponding to system calls include, for example, another process besides the process that implements the execution environment that operates on the host OS 1410, and the like. The various types of processes corresponding to system calls include, for example, another process besides the process that implements the execution environment that operates on a VM that operates on the host OS 1410, and the like.

For example, a conceivable case is that the collected data recording unit 1421 identifies another process besides the process that implements the execution environment that operates on the host OS 1410 as a process corresponding to the system call. In this case, the collected data recording unit 1421 adds a suffix “system call name”+“host” to the system call.

Furthermore, for example, a conceivable case is that the collected data recording unit 1421 identifies a VM or a container that operates as the process that implements the execution environment on the host OS 1410 as a process corresponding to the system call. In this case, the collected data recording unit 1421 adds a suffix “system call name”+“VM name of the identified VM or container name of the identified container” to the system call.

Furthermore, for example, a conceivable case is that the collected data recording unit 1421 identifies the VM that operates on the host OS 1410 and the container that operates as the process that implements the execution environment on the VM, as processes corresponding to the system call. In this case, the collected data recording unit 1421 adds a suffix “system call name”+“VM name of the identified VM”+“container name of the identified container” to the system call.

The collected data recording unit 1421 outputs output data 1440 that summarizes a result of adding the suffix so that the user may refer thereto. Thus, the monitoring device 100 may make it easier for the user to identify the factor that has caused the system call. Since the monitoring device 100 does not have to detect the system call generated on the VM, it is applicable to the situation where the VM and the container operate in a hierarchical structure on the host OS 1410. Next, the description proceeds to FIG. 15.

In FIG. 15, the collected data recording unit 1421 identifies the host time at which the system call has occurred on the time axis illustrated in a graph 1500 on the basis of the system call management table 800. The collected data recording unit 1421 identifies the host time when the VM has switched to the operating state and identifies the period during which the VM is in the operating state on the time axis illustrated in the graph 1500, on the basis of the VM switching information management table 900. The collected data recording unit 1421 identifies the host time when the process has switched to the operating state on the VM and identifies the period during which the process is in the operating state on the VM on the time axis illustrated in the graph 1500, on the basis of the on-VM process switching information management table 1000.

In this manner, the collected data recording unit 1421 identifies the host time when the system call has occurred, the host time when the VM has switched to the operating state, and the host time when the process has switched to the operating state on the VM, on the same time axis illustrated in the graph 1500. Thus, the collected data recording unit 1421 may make it easy to accurately identify which VM and which process that operates on which VM correspond to the system call on the basis of the host time.

In the example of FIG. 15, because the system call “syscall-A” has occurred during the operation of container1 on VM1, the collected data recording unit 1421 determines that the system call “syscall-A” corresponds to container1 on VM1. Thus, the collected data recording unit 1421 acquires the system call name “syscall-A” of the system call, the VM name “VM1” of VM1, and the container name “container1” of container1 on the basis of the various types of tables 500 to 1000.

The collected data recording unit 1421 acquires the system call name on the basis of, for example, the system call management table 800. The collected data recording unit 1421 acquires the VM name corresponding to VM1 discrimination information of VM1 on the basis of, for example, the first mapping information management table 500 and the VM switching information management table 900. The collected data recording unit 1421 acquires the container name corresponding to on-VM1 container1 discrimination information of container1 on the basis of, for example, the second mapping information management table 600 and the on-VM process switching information management table 1000. Then, the collected data recording unit 1421 adds a suffix “syscall-A-VM1-container1” in which the various types of names acquired are combined to the system call.

Furthermore, because the system call “syscall-B” has occurred during the operation of container2 on VM1, the collected data recording unit 1421 determines that the system call “syscall-B” corresponds to container2 on VM1. Thus, the collected data recording unit 1421 acquires the system call name “syscall-B” of the system call, the VM name “VM1” of VM1, and the container name “container2” of container2 on the basis of the various types of tables 500 to 1000. Then, the collected data recording unit 1421 adds a suffix “syscall-B-VM1-container2” in which the various types of names acquired are combined to the system call.

Furthermore, because the system call “syscall-C” has occurred during the operation of container3 on VM2, the collected data recording unit 1421 determines that the system call “syscall-C” corresponds to container3 on VM2. Thus, the collected data recording unit 1421 acquires the system call name “syscall-C” of the system call, the VM name “VM2” of VM2, and the container name “container3” of container3 on the basis of the various types of tables 500 to 1000. Then, the collected data recording unit 1421 adds a suffix “syscall-C-VM2-container3” in which the various types of names acquired are combined to the system call.

The collected data recording unit 1421 generates output data 1510 that summarizes a result of adding the suffix, and outputs the output data 1510 so that the user may refer thereto. Thus, the monitoring device 100 may enable the user to grasp which VM the system call of the host OS 1410 is related to and which process that operates on which VM the system call of the host OS 1410 is related to. In this manner, the monitoring device 100 may make it easy for the user to identify the factor that has caused the system call of the host OS 1410. Next, the description proceeds to FIG. 16.

In FIG. 16, the collected data recording unit 1421 identifies the host time at which the system call has occurred on the time axis illustrated in a graph 1600 on the basis of the system call management table 800. The collected data recording unit 1421 identifies the host time when the VM has switched to the operating state and identifies the period during which the VM is in the operating state on the time axis illustrated in the graph 1600, on the basis of the VM switching information management table 900. The collected data recording unit 1421 identifies the host time when the process has switched to the operating state on the VM and identifies the period during which the process is in the operating state on the VM on the time axis illustrated in the graph 1600, on the basis of the on-VM process switching information management table 1000.

In this manner, the collected data recording unit 1421 identifies the host time when the system call has occurred, the host time when the VM has switched to the operating state, and the host time when the process has switched to the operating state on the VM, on the same time axis illustrated in the graph 1600. Thus, the collected data recording unit 1421 may make it easy to accurately identify which VM and which process that operates on which VM correspond to the system call on the basis of the host time.

In the example of FIG. 16, because a system call “syscall-D” has occurred during operation of process1 on the host OS 1410, the collected data recording unit 1421 determines that the system call “syscall-D” corresponds to process1 on the host OS 1410. In this manner, the collected data recording unit 1421 acquires the system call name “syscall-D” of the system call on the basis of the various types of tables 500 to 1000. Then, the collected data recording unit 1421 adds a suffix “syscall-D-host” in which a character string “host” is combined with the acquired system call name “syscall-D” to the system call.

Furthermore, because a system call “syscall-E” has occurred during operation of process2 on VM1, the collected data recording unit 1421 determines that the system call “syscall-E” corresponds to process2 on VM1. Thus, the collected data recording unit 1421 acquires the system call name “syscall-E” of the system call and the VM name “VM1” of VM1 on the basis of the various types of tables 500 to 1000. Then, the collected data recording unit 1421 adds a suffix “syscall-E-VM1” in which the various types of names acquired are combined to the system call.

Furthermore, because a system call “syscall-F” has occurred during the operation of a process process3 on container1, the collected data recording unit 1421 determines that the system call “syscall-F” corresponds to process3 on container1. Thus, the collected data recording unit 1421 acquires the system call name “syscall-F” of the system call and the container name “container1” of container1 on the basis of the various types of tables 500 to 1000. Then, the collected data recording unit 1421 adds a suffix “syscall-F-container1” in which the various types of names acquired are combined to the system call.

The collected data recording unit 1421 generates output data 1610 that summarizes a result of adding the suffix, and outputs the output data 1610 so that the user may refer thereto. Thus, the monitoring device 100 may enable the user to grasp whether the system call of the host OS 1410 is related to the process of the host OS 1410, which VM or container on the host OS 1410 the system call of the host OS 1410 is related to, and the like. In this manner, the monitoring device 100 may make it easy for the user to identify the factor that has caused the system call of the host OS 1410.

Second Specific Example of Operation of Monitoring Device

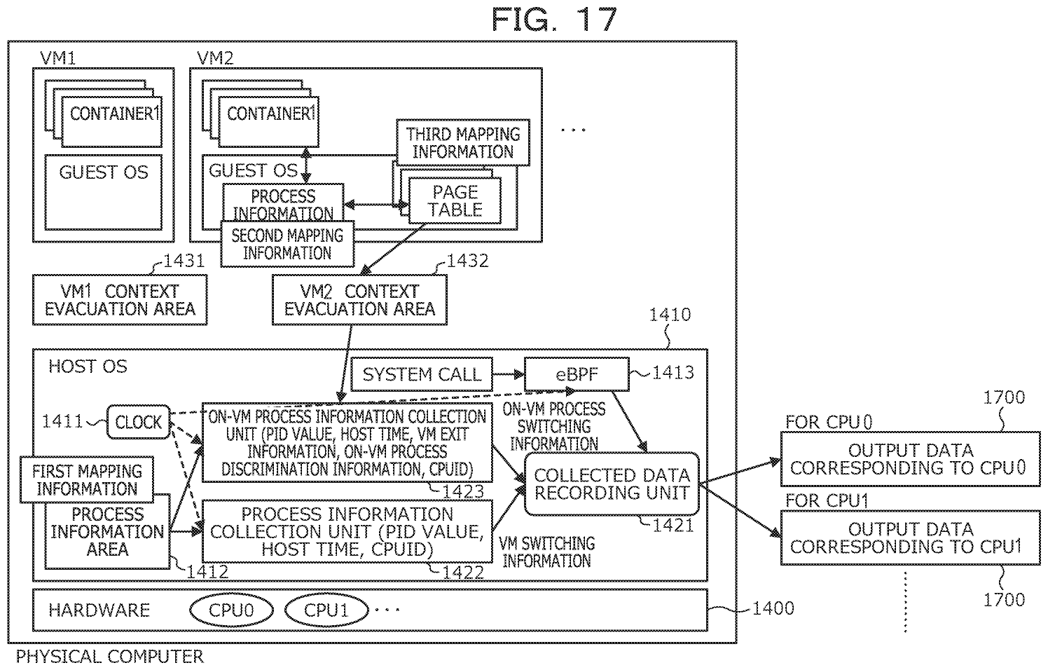

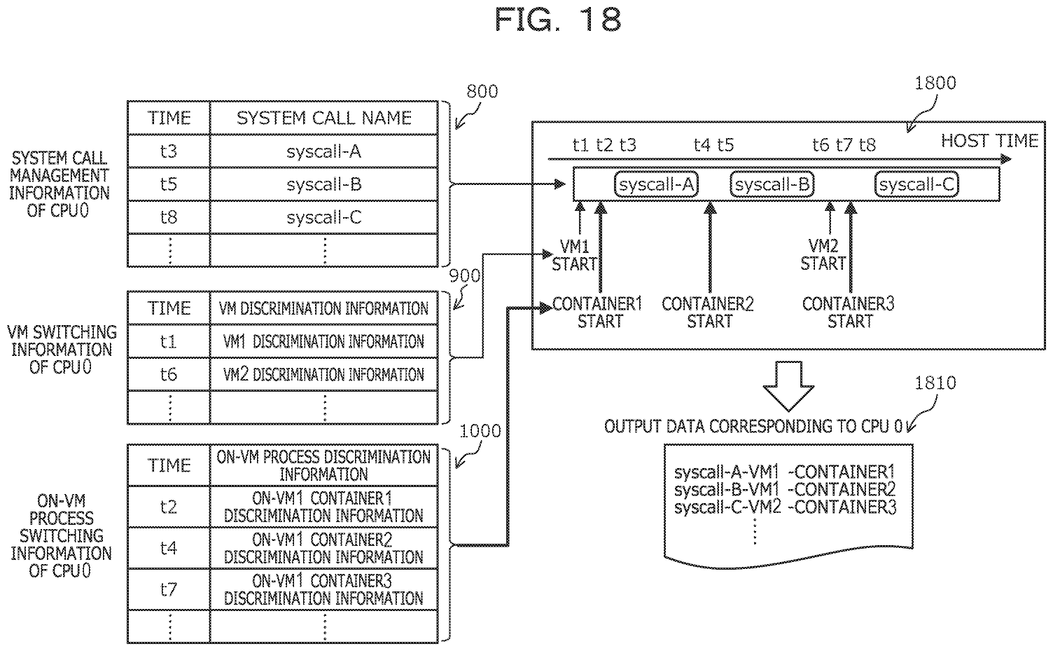

Next, a second specific example of the operation of the monitoring device 100 will be described with reference to FIGS. 17 and 18.

FIGS. 17 and 18 are explanatory diagrams illustrating a second specific example of the operation of the monitoring device 100. In FIG. 17, the monitoring device 100 has a host OS 1410 that operates on a hardware 1400. The hardware 1400 includes a plurality of CPUs. The hardware 1400 includes, for example, CPUs CPU0 and CPU1. On the host OS 1410, a plurality of VMs operates while switching to each other. On the host OS 1410, for example, VMs VM1 and VM2 operate while switching to each other. Each VM has a guest OS.

The host OS 1410 has a clock 1411, a process information area 1412, and an eBPF function 1413. The host OS 1410 has a collected data recording unit 1421, an on-host-OS process information collection unit 1422, and an on-VM process information collection unit 1423. The monitoring device 100 has, for each VM, a VM context evacuation area corresponding to the VM. The monitoring device 100 has, for example, a VM1 context evacuation area 1431 and a VM2 context evacuation area 1432.

The monitoring device 100 collects the first mapping information, the second mapping information, and the third mapping information, and transmits the first mapping information, the second mapping information, and the third mapping information to the collected data recording unit 1421. The monitoring device 100 collects, for example, PID values of a VM and a container that operate as processes on the host OS 1410. Then, the monitoring device 100 generates, for example, the first mapping information that includes information in which the collected PID value of the VM is associated with a VM name of the VM and information in which the collected PID value of the container is associated with a container name of the container.

The monitoring device 100 causes a PID value and a container name of a container that operates on a VM to be collected in the VM, and causes the second mapping information that includes information in which the collected PID value and container name of the container are associated with a VM name of the VM to be generated in the VM. The monitoring device 100 acquires the generated second mapping information.

The monitoring device 100 causes a page table start address and a PID value of a process managed by the guest OS on a VM to be collected in the VM. The monitoring device 100 causes the third mapping information that includes information in which a VM name of the VM is associated with the page table start address and PID value collected in the VM to be generated in the VM. The monitoring device 100 acquires the generated third mapping information.

Host OS 1410 uses the eBPF function 1413 to detect that a system call has occurred for any CPU. The host OS 1410 generates system call management information in which a CPUID of the CPU, a system call name of the detected system call, and a host time measured by the clock 1411 when it is detected are associated with each other, and transmits the system call management information to the collected data recording unit 1421. The collected data recording unit 1421 stores the received system call management information in the system call management table 800.

The on-host-OS process information collection unit 1422 sets a hook in a context switch function. The hook specifies, for example, new processing for detecting that a VM has switched to the operating state. The on-host-OS process information collection unit 1422 detects that a VM that uses one of the CPUs has switched to the operating state by using the hook set in the context switch function, and acquires a CPUID of that CPU and a PID value of the VM. The on-host-OS process information collection unit 1422 generates the VM switching information in which the acquired CPUID, a VM name of the VM, the acquired PID value, and a host time measured by the clock 1411 when it is detected are associated with each other, and transmits the VM switching information to the collected data recording unit 1421. The collected data recording unit 1421 stores the received VM switching information in the VM switching information management table 900.

The on-VM process information collection unit 1423 sets a hook in a VM handler function. The hook specifies new processing for detecting that a certain process has switched to the operating state on a VM. The on-VM process information collection unit 1423 detects that a certain process that uses one of the CPUs has switched to the operating state on a VM by using the hook set in the VM handler function, and acquires a CPUID of the CPU and a discrimination information that discriminates the process.

The on-VM process information collection unit 1423 collects the VM exit information and the on-VM process discrimination information from the VM context evacuation area by using the hook set in the VM handler function, for example. The on-VM process discrimination information is, for example, a page table start address corresponding to a process on the VM. Furthermore, the on-VM process information collection unit 1423 acquires, for example, a CPUID of the CPU used by the VM.

For example, the on-VM process information collection unit 1423 collects the VM exit information and the page table start address that is the on-VM process discrimination information from the VM context evacuation area. For example, the on-VM process information collection unit 1423 identifies a PID value corresponding to the collected page table start address on the basis of the third mapping information. For example, the on-VM process information collection unit 1423 acquires a CPUID of the CPU. For example, the on-VM process information collection unit 1423 acquires a host time measured by the clock 1411 when it is collected.

For example, the on-VM process information collection unit 1423 determines whether or not a factor that has caused control transfer from a VM to the host OS 1410 is switching of a process that operates on the VM on the basis of the collected VM exit information. For example, when an exit reason number included in the VM exit information is 9, the on-VM process information collection unit 1423 determines that the factor that has caused the control transfer from the VM to the host OS 1410 is the switching of the process that operates on the VM.

Here, for example, a conceivable case is that the on-VM process information collection unit 1423 determines that the switching of the process that operates on the VM is the factor. In this case, the on-VM process information collection unit 1423, for example, generates the on-VM process switching information in which the acquired CPUID, the VM name of the VM, the identified PID value, and the acquired host time are associated with each other, and transmits the on-VM process switching information to the collected data recording unit 1421. On the other hand, a conceivable case is that, for example, the on-VM process information collection unit 1423 determines that the switching of the process that operates on the VM is not the factor. In this case, the on-VM process information collection unit 1423 does not, for example, generate the on-VM process switching information. The collected data recording unit 1421 stores the received on-VM process switching information in the on-VM process switching information management table 1000.

The collected data recording unit 1421 identifies various types of process corresponding to system calls for each CPU on the basis of the various types of tables 500 to 1000, and adds a suffix to the system call on the basis of a result of the identification. For example, a specific example in which the collected data recording unit 1421 identifies various types of processes corresponding to system calls will be described later with reference to FIG. 18.

The collected data recording unit 1421 outputs output data 1700 that summarizes a result of adding the suffix for each CPU so that the user may refer thereto. Thus, the monitoring device 100 may make it easier for the user to identify the factor that has caused the system call. Since the monitoring device 100 does not have to detect the system call generated on the VM, it is applicable to the situation where the VM and the container operate in a hierarchical structure on the host OS 1410. Next, the description proceeds to FIG. 18.

In FIG. 18, the collected data recording unit 1421 identifies a host time at which a system call related to a CPU has occurred for each CPU on the time axis illustrated in a graph 1800 on the basis of the system call management table 800. The collected data recording unit 1421 identifies a host time when a VM that uses a CPU has switched to the operating state for each CPU and identifies a period during which the VM is in the operating state on the time axis illustrated in the graph 1800, on the basis of the VM switching information management table 900.

The collected data recording unit 1421 identifies a host time when a process has switched to the operating state on a VM that uses a CPU for each CPU on the time axis illustrated in the graph 1800 on the basis of the on-VM process switching information management table 1000. The collected data recording unit 1421 identifies a period during which the process is in the operating state on the VM on the basis of the identified host time.

In this manner, the collected data recording unit 1421 identifies the host time when the system call has occurred, the host time when the VM has switched to the operating state, and the host time when the process has switched to the operating state on the VM, on the same time axis illustrated in the graph 1800. Thus, the collected data recording unit 1421 may make it easy to accurately identify which VM and which process that operates on which VM correspond to the system call on the basis of the host time.

In the example of FIG. 18, because the system call “syscall-A” related to CPU0 has occurred during the operation of container1 on VM1, the collected data recording unit 1421 determines that the system call “syscall-A” corresponds to container1 on VM1. Thus, the collected data recording unit 1421 acquires the system call name “syscall-A” of the system call, the VM name “VM1” of VM1, and the container name “containert” of container1 on the basis of the various types of tables 500 to 1000. Then, the collected data recording unit 1421 adds the suffix “syscall-A-VM1-container1” in which the various types of names acquired are combined to the system call.

Furthermore, because the system call “syscall-B” related to CPU0 has occurred during the operation of container2 on VM1, the collected data recording unit 1421 determines that the system call “syscall-B” corresponds to container2 on VM1. Thus, the collected data recording unit 1421 acquires the system call name “syscall-B” of the system call, the VM name “VM1” of VM1, and the container name “container2” of container2 on the basis of the various types of tables 500 to 1000. Then, the collected data recording unit 1421 adds the suffix “syscall-B-VM1-container2” in which the various types of names acquired are combined to the system call.

Furthermore, because the system call “syscall-C” related to CPU0 has occurred during the operation of container3 on VM2, the collected data recording unit 1421 determines that the system call “syscall-C” corresponds to container3 on VM2. Thus, the collected data recording unit 1421 acquires the system call name “syscall-C” of the system call, the VM name “VM2” of VM2, and the container name “container3” of container3 on the basis of the various types of tables 500 to 1000. Then, the collected data recording unit 1421 adds the suffix “syscall-C-VM2-container3” in which the various types of names acquired are combined to the system call.

The collected data recording unit 1421 generates output data 1810 corresponding to CPU0 that summarizes a result of adding the suffix to the system call for CPU0, and outputs the output data 1810 so that the user may refer thereto. Similarly, the collected data recording unit 1421 generates output data corresponding to another CPU that summarizes a result of adding the suffix to the system call for the other CPU, and outputs the output data so that the user may refer thereto. Thus, the monitoring device 100 may enable the user to grasp which VM the system call of the host OS 1410 is related to and which process that operates on which VM the system call of the host OS 1410 is related to, for each CPU. In this manner, the monitoring device 100 may make it easy for the user to identify the factor that has caused the system call of the host OS 1410.

Overall Processing Procedure

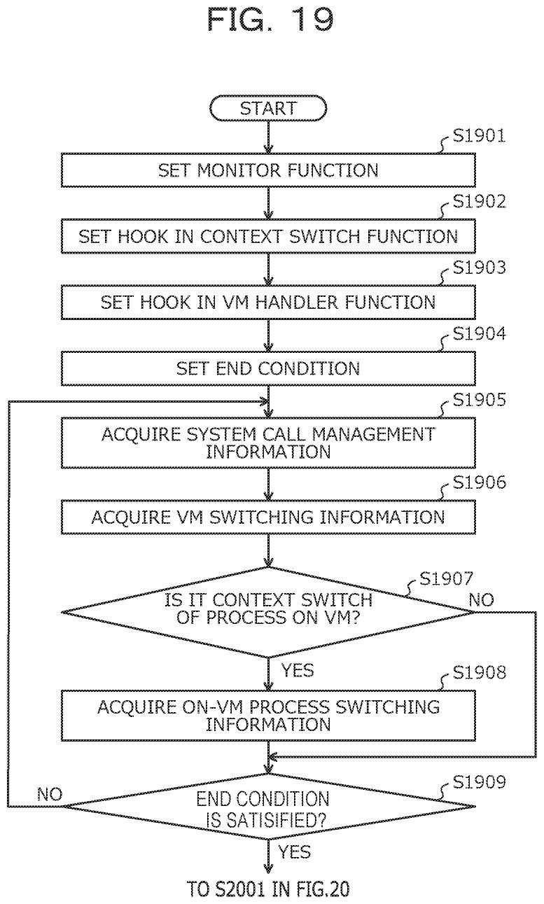

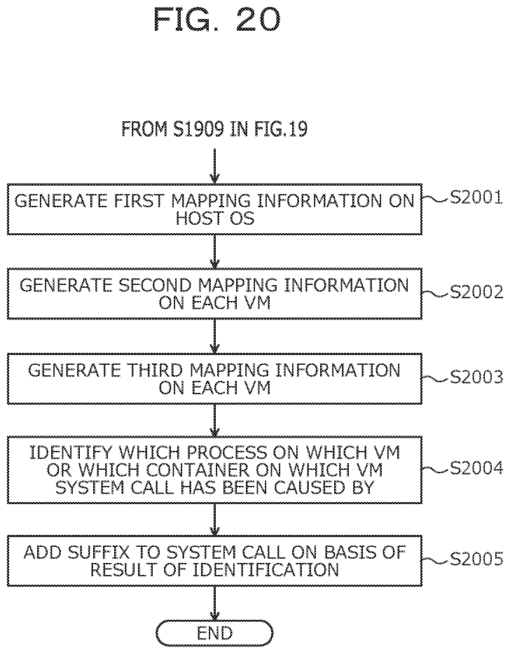

Next, one example of an overall processing procedure executed by the monitoring device 100 will be described with reference to FIGS. 19 and 20. The overall processing is implemented by, for example, the CPU 401 illustrated in FIG. 4, the storage area of the memory 402, the recording medium 405, or the like, and the network I/F 403.

FIGS. 19 and 20 are flowcharts illustrating one example of the overall processing procedure. In FIG. 19, the monitoring device 100 sets a monitor function (step S1901). Next, the monitoring device 100 sets a hook in a context switch function (step S1902). Then, the monitoring device 100 sets a hook in a VM handler function (step S1903).

Next, the monitoring device 100 sets an end condition (step S1904). Then, the monitoring device 100 acquires system call management information by using the set monitor function (step S1905). Next, the monitoring device 100 acquires VM switching information by using the hook of the context switch function (step S1906). Then, the monitoring device 100 determines whether or not a VM-exit factor from a VM to the host OS is a context switch of a process on the VM (step S1907).

Here, when it is determined that the VM-exit factor from a VM to the host OS is not a context switch of a process on the VM (step S1907: No), the monitoring device 100 proceeds to processing of step S1909. On the other hand, when it is determined that the VM-exit factor from a VM to the host OS is a context switch of a process on the VM (step S1907: Yes), the monitoring device 100 shifts to processing of step S1908.

In step S1908, the monitoring device 100 acquires on-VM process switching information by using the hook of the VM handler function (step S1908). Then, the monitoring device 100 proceeds to the processing of step S1909.

In step S1909, the monitoring device 100 determines whether or not the end condition is satisfied (step S1909). Here, when it is determined that the end condition is not satisfied (step S1909: No), the monitoring device 100 returns to the processing of step S1905. On the other hand, when it is determined that the end condition is satisfied (step S1909: Yes), the monitoring device 100 proceeds to processing of step S2001 in FIG. 20.

In FIG. 20, the monitoring device 100 generates first mapping information on the host OS (step S2001). Next, the monitoring device 100 generates second mapping information on each VM (step S2002). Then, the monitoring device 100 generates third mapping information on each VM (step S2003).

Next, the monitoring device 100 identifies which process on which VM or which container on which VM the system call has been caused by, on the basis of various types of mapping information (step S2004). The various types of mapping information are the first mapping information, the second mapping information, and the third mapping information. Then, the monitoring device 100 adds a suffix to the system call on the basis of a result of the identification (step S2005). Thereafter, the monitoring device 100 ends the overall processing.

Here, the monitoring device 100 may change the order of processing of some steps in the flowcharts of FIGS. 19 and 20 and execute the processing. For example, the order of the processing of step S1905, processing of step S1906, and processing of steps S1907 and S1908 may be exchanged. For example, the order of the processing of step S2001, processing of step S2002, and processing of step S2003 may be exchanged.

As described above, with the monitoring device 100, it is possible to detect an occurrence time point when a system call of a host OS has occurred. With the monitoring device 100, it is possible to acquire operation information that enables a switching time point to be identified. The switching time point is a time point when a process that implements an execution environment, which is in operation on the host OS and is isolated from the host OS, has switched. With the monitoring device 100, it is possible to identify a process that implements one of execution environments, which is in operation on the host OS, at the detected occurrence time point on the basis of the acquired operation information. With the monitoring device 100, it is possible to output the identified process that implements one of the execution environments in association with the system call. Thus, the monitoring device 100 may make it easy to identify the factor that has caused the system call of the host OS.

With the monitoring device 100, it is possible to acquire first operation information that enables a first switching time point to be identified. The first switching time point is a time point when a VM in operation on the host OS has switched. With the monitoring device 100, it is possible to identify a VM, which is in operation on the host OS, at the detected occurrence time point on the basis of the acquired first operation information. With the monitoring device 100, it is possible to output the identified VM in association with the system call. Thus, the monitoring device 100 may enable the user to grasp the VM that is a candidate for the factor that has caused the system call of the host OS. In this manner, the monitoring device 100 may make it easy to identify the factor that has caused the system call of the host OS.

With the monitoring device 100, it is possible to detect that a process in operation on the host OS has switched to a certain VM by using a first function that operates when switching a process in operation on the host OS. With the monitoring device 100, the first operation information may be generated by associating the VM with a time point measured by the host OS. Thus, the monitoring device 100 may relatively easily generate the first operation information.

With the monitoring device 100, it is possible to acquire second operation information that enables a second switching time point to be identified. The second switching time point is a time point when a container in operation on the VM in operation on the host OS has switched. With the monitoring device 100, it is possible to identify a VM in operation on the host OS and a container in operation on the VM at the detected occurrence time point on the basis of the acquired first operation information and the acquired second operation information. With the monitoring device 100, the identified VM and the identified container may be output in association with the system call. Thus, the monitoring device 100 may enable the user to grasp a combination of the VM and the container, which are candidates for the factor that has caused the system call of the host OS. In this manner, the monitoring device 100 may make it easy to identify the factor that has caused the system call of the host OS.

With the monitoring device 100, it is possible to detect, by using a second function that operates when control transfer from a VM to the host OS is performed, a container in operation on the VM immediately before the control transfer. With the monitoring device 100, it is possible to generate the second operation information by associating the detected container with a time point measured by the host OS. Thus, the monitoring device 100 may be applied to a situation where it is difficult to grasp the inside of the VM directly from the host OS.

With the monitoring device 100, it is possible to acquire a resource usage status of a process that operates on the host OS and implements an execution environment isolated from the host OS. With the monitoring device 100, it is possible to detect an occurrence time point when a system call of the host OS has occurred for a process of which the resource usage status acquired satisfies a condition. Thus, the monitoring device 100 may limit a system call of the host OS as a processing target, and may reduce the processing amount. At this time, the monitoring device 100 may set a system call of the host OS as a processing target, which is determined to be relatively important, while reducing the processing amount, and may prevent deterioration of practicality.

With the monitoring device 100, it is possible to detect that a waiting time has occurred in a process that operates on the host OS and implements an execution environment isolated from the host OS. With the monitoring device 100, it is possible to detect an occurrence time point when a system call of the host OS has occurred for the process in which a waiting time has occurred. Thus, the monitoring device 100 may limit a system call of the host OS as a processing target, and may reduce the processing amount. At this time, the monitoring device 100 may set a system call of the host OS as a processing target, which is determined to be relatively important, while reducing the processing amount, and may prevent deterioration of practicality.

With the monitoring device 100, it is possible to detect an occurrence time point when a system call of the host OS has occurred in any arithmetic unit of a plurality of arithmetic units. With the monitoring device 100, it is possible to acquire operation information that enables a switching time point to be identified. The switching time point is a time point when a process that implements an execution environment, which is in operation on the host OS and is isolated from the host OS, in any of the arithmetic units has switched. With the monitoring device 100, it is possible to identify a process that implements any of the execution environments in operation on the host OS at the detected occurrence time point in any of the arithmetic units, on the basis of the acquired operation information. Thus, the monitoring device 100 may make it easy to identify the factor that has caused the system call of the host OS for each arithmetic unit.

With the monitoring device 100, it is possible to acquire third operation information that enables a third switching time point to be identified. The third switching time point is a time point when a process in operation on the host OS has switched. With the monitoring device 100, it is possible to identify a process in operation on the host OS at the detected occurrence time point on the basis of the acquired third operation information. With the monitoring device 100, it is possible to output the identified process in association with the system call. Thus, the monitoring device 100 may enable the user to grasp a process in operation on the host OS, which is a candidate for the factor that has caused the system call of the host OS. In this manner, the monitoring device 100 may make it easy for the user to identify the factor that has caused the system call of the host OS.

With the monitoring device 100, it is possible to acquire fourth operation information that enables a fourth switching time point to be identified. The fourth switching time point is a time point when a process in operation on a VM in operation on the host OS has switched. With the monitoring device 100, it is possible to identify, on the basis of the acquired first operation information and the acquired fourth operation information, a VM in operation on the host OS and a process in operation on the VM at the detected occurrence time point. With the monitoring device 100, the identified VM and the identified process may be output in association with the system call. Thus, the monitoring device 100 may enable the user to grasp a process in operation on a VM in operation on the host OS, which is a candidate for the factor that has caused the system call of the host OS. In this manner, the monitoring device 100 may make it easy for the user to identify the factor that has caused the system call of the host OS.

Note that the factor identification method described in the present embodiment may be implemented by executing a program prepared in advance on a computer such as a PC or a workstation. The program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a factor identification process, the factor identification process comprising:
detecting an occurrence time point when a system call of a host operating system (OS) has occurred;
acquiring switching operation information that enables an environment switching time point to be identified, the environment switching time point being a time point when an environmental process has switched, the environmental process implementing a software execution environment which is in operation on the host OS and is isolated from the host OS;
identifying, based on the switching operation information, a first environmental process which is in operation on the host OS at the occurrence time point; and
outputting the first environmental process in association with the system call.

2. The non-transitory computer-readable recording medium storing a program according to claim 1, the factor identification process further comprising:
acquiring first operation information that enables a first switching time point to be identified, the first switching time point being a time point when a virtual machine in operation on the host OS has switched;
identifying a first virtual machine, which is in operation on the host OS at the occurrence time point, based on the first operation information; and
outputting the first virtual machine in association with the system call.

3. The non-transitory computer-readable recording medium storing a program according to claim 2, wherein
the program operates on the host OS, and
the factor identification process further comprises:
detecting that a first process in operation on the host OS has switched to the first virtual machine by using a first function that operates when a process in operation on the host OS is switched; and
generating the first operation information by associating the first virtual machine with a time point measured by the host OS.

4. The non-transitory computer-readable recording medium storing a program according to claim 2, the factor identification process further comprising:
acquiring second operation information that enables a second switching time point to be identified, the second switching time point being a time point when a second process or a container in operation on the first virtual machine has switched;
identifying the first virtual machine and the second process or the container based on the first operation information and the second operation information; and
outputting the first virtual machine and the second process or the container in association with the system call.

5. The non-transitory computer-readable recording medium storing a program according to claim 4, the factor identification process further comprising:
detecting, by using a second function that operates when control transfer from the first virtual machine to the host OS is performed, the second process or the container immediately in operation on the first virtual machine before the control transfer; and
generating the second operation information by associating the second process or the container with a time point measured by the host OS.

6. The non-transitory computer-readable recording medium storing a program according to claim 1, the factor identification process further comprising:
acquiring a resource usage status of each environmental process that operates on the host OS; and
detecting the occurrence time point for an environmental process of which the resource usage status acquired satisfies a predetermined condition.

7. The non-transitory computer-readable recording medium storing a program according to claim 1, the factor identification process further comprising:
detecting that a waiting time has occurred in an environmental process that operates on the host OS; and
detecting the occurrence time point for an environmental process in which the waiting time has occurred.

8. The non-transitory computer-readable recording medium storing a program according to claim 1, wherein
the computer includes a plurality of arithmetic units, and
the factor identification process further comprises:
detecting the occurrence time point in a first arithmetic unit among the plurality of arithmetic units;
acquiring the switching operation information for the first arithmetic unit; and
identifying the first environmental process on the first arithmetic unit based on the acquired switching operation information.

9. The non-transitory computer-readable recording medium storing a program according to claim 1, the factor identification process further comprising:
acquiring first operation information that enables a first switching time point to be identified, the first switching time point being a time point when a process in operation on the host OS has switched;
identifying a process in operation on the host OS at the occurrence time point based on the first operation information; and
outputting the identified process in association with the system call.

10. A factor identification method, comprising:
detecting, by a computer, an occurrence time point when a system call of a host operating system (OS) has occurred;
acquiring switching operation information that enables an environment switching time point to be identified, the environment switching time point being a time point when an environmental process has switched, the environmental process implementing a software execution environment which is in operation on the host OS and is isolated from the host OS;
identifying, based on the switching operation information, a first environmental process which is in operation on the host OS at the occurrence time point; and
outputting the first environmental process in association with the system call.

11. An information processing device, comprising:
a memory; and
a processor coupled to the memory and the processor configured to:
detect an occurrence time point when a system call of a host operating system (OS) has occurred;
acquire switching operation information that enables an environment switching time point to be identified, the environment switching time point being a time point when an environmental process has switched, the environmental process implementing a software execution environment which is in operation on the host OS and is isolated from the host OS;
identify, based on the switching operation information, a first environmental process which is in operation on the host OS at the occurrence time point; and
output the first environmental process in association with the system call.
